(19) United States
(12) Patent Application Publication
(10) Pub. No.: US 2018/0336816 A1
(43) Pub. Date: Nov. 22, 2018

(54) DISPLAY DRIVER CIRCUIT FOR PRE-EMPHASIS OPERATION

(71) Applicant: Samsung Electronics Co., Ltd., Suwon-si (KR)

(72) Inventors: Young Min Shin, Seongnam-si (KR); Yong-Hun KIM, Seoul (KR); Yeonwoo JUNG, Seoul (KR)

(21) Appl. No.: 15/917,073

(22) Filed: Mar. 9, 2018

(30) Foreign Application Priority Data
May 19, 2017 (KR) 10-2017-0062510
May 24, 2017 (KR) 10-2017-0064329
Nov. 1, 2017 (KR) 10-2017-0144963

(51) Int. Cl. G09G 3/32; H04N 5/202

(52) U.S. Cl. CPC G09G 3/32; G09G 2310/0243; G09G 2310/0264; H04N 5/202

(57) ABSTRACT

A display driver circuit includes a comparator that is configured to compare first pixel data of a plurality of pixel data with second pixel data of the plurality of pixel data, the plurality of pixel data respectively corresponding to a plurality of pixels connected to a data line, a pre-emphasis controller configured to calculate an offset based on a compare result of the comparator and gamma segment points, which are adjacent to the second pixel data, from among a plurality of gamma segment points used as a reference for dividing the plurality of pixel data, a calculator configured to calculate pre-emphasis pixel data based on the second pixel data and the offset, and an output circuit configured to transmit a pre-emphasis gray scale voltage corresponding to the pre-emphasis pixel data and a target gray scale voltage corresponding to the second pixel data to a display panel through the data line.

### CROSS-REFERENCE TO RELATED APPLICATIONS

This U.S. non-provisional patent application claims priority under 35 U.S.C. § 119 to Korean Patent Applications Nos. 10-2017-0062510, 10-2017-0064329, and 10-2017-0144963, respectively filed on May 19, 2017, May 24, 2017, and Nov. 1, 2017 in the Korean Intellectual Property Office, the entire contents of which are incorporated herein by reference.

### TECHNICAL FIELD

Embodiments of the inventive concept disclosed herein relate to a display driver circuit, and, more particularly, relate to a display driver circuit for a pre-emphasis operation.

### DESCRIPTION OF THE RELATED ART

A display panel may include gate lines arranged in a row direction, data lines arranged in a column direction, and pixels arranged at intersections of the gate lines and the data lines. A data driver may provide image signals (i.e., gray scale voltages) to the pixels through the data lines in the column direction. If any image data are provided, the data driver may output gray scale voltages to the pixels to allow an image to be displayed in the display panel.

As the size and resolution of the display panel increase, magnitudes of a load resistor and a load capacitor connected to an output of the data driver may increase, and, thus, a target voltage of an image signal may increase corresponding to the increase in magnitude of the target voltage. A slew rate of an amplifier of the data driver may decrease due to the increase in the load resistance and load capacitance. A pre-emphasis operation may be used to increase the slew rate of the amplifier of the data driver because of changes in the level of a gray scale voltage.

### SUMMARY

Embodiments of the inventive concept provide a display driver circuit for a pre-emphasis operation.

According to some embodiments, a display driver circuit may include a comparator configured to compare first pixel data of a plurality of pixel data with second pixel data of the plurality of pixel data, the plurality of pixel data respectively corresponding to a plurality of pixels connected to a data line, a pre-emphasis controller configured to calculate an offset based on a compare result of the comparator and gamma segment points, which are adjacent to the second pixel data, from among a plurality of gamma segment points used as a reference for dividing the plurality of pixel data, a calculator configured to calculate pre-emphasis pixel data based on the second pixel data and the offset, and an output circuit configured to transmit a pre-emphasis gray scale voltage corresponding to the pre-emphasis pixel data and a target gray scale voltage corresponding to the second pixel data to a display panel through the data line.

According to some embodiments, a display driver circuit may include a comparator configured to compare first pixel data with second pixel data to be output to a first pixel of a plurality of pixels and a second pixel of the plurality pixels through a data line, respectively, a register configured to store a plurality of line segment points used as a reference for dividing the plurality of pixels connected through the data line into a plurality of line segments, a pre-emphasis controller configured to calculate an offset based on a compare result of the comparator and adjusts a period, during which the offset is output to the second pixel, based on ones of the line segment points of the plurality of line segment points adjacent to the second pixel, and an output circuit that outputs the second pixel data and the offset to the second pixel through the data line based on the period adjusted by the pre-emphasis controller.

According to an exemplary embodiment, a display driver circuit may include a comparator configured to compare first pixel data with second pixel data to be output to a first pixel and a second pixel through a data line, respectively, a pre-emphasis controller configured to calculate an offset based on a compare result of the comparator, a calculator configured to calculate pre-emphasis pixel data based on the second pixel data and the offset, a gray scale voltage generator configured to generate a pre-emphasis gray scale voltage corresponding to the pre-emphasis pixel data and a target gray scale voltage corresponding to the second pixel data, and an output circuit configured to output the pre-emphasis gray scale voltage and the target gray scale voltage to a display panel through the data line. A range of the pre-emphasis gray scale voltage may include a range of the target gray scale voltage and a range of an expected gray scale voltage except for the range of the target gray scale voltage.

It is noted that aspects of the inventive concepts described with respect to one embodiment, may be incorporated in a different embodiment although not specifically described relative thereto. That is, all embodiments and/or features of any embodiment can be combined in any way and/or combination. These and other aspects of the inventive concepts are described in detail in the specification set forth below.

### BRIEF DESCRIPTION OF THE FIGURES

The above and other features of embodiments of the inventive concept will become more apparent from the following detailed description of embodiments thereof with reference to the accompanying drawings.

FIG. 1 is a block diagram illustrating a display device according to some embodiments of the inventive concept.

FIG. 2 is a block diagram illustrating a display device of FIG. 1 according to some embodiments of the inventive concept.

FIG. 3 is a circuit diagram in which an output circuit illustrated in FIG. 2 and pixels and a data line connected to the output circuit are modeled according to some embodiments of the inventive concept.

FIG. 4 is a timing diagram illustrating operations of an amplifier shown in FIG. 3 according to some embodiments of the inventive concept.

FIG. 5 is a block diagram illustrating a data decoder shown in FIG. 2 according to some embodiments of the inventive concept.

FIG. 6 is a view illustrating a gamma curve of pixel data versus a gray scale voltage according to some embodiments of the inventive concept.

FIG. 7 is a view illustrating a gamma curve linearized by gamma segment points according to some embodiments of the inventive concept.

FIG. 8 is a flowchart illustrating operations in which a pre-emphasis controller illustrated in FIG. 5 generates an offset according to some embodiments of the inventive concept.

FIGS. 9 and 10 are views illustrating operations in which a pre-emphasis controller illustrated in FIG. 5 sets a pre-emphasis period based on line segment points according to some embodiments of the inventive concept.

FIGS. 11 and 12 are views illustrating operations in which a pre-emphasis controller shown in FIG. 5 sets a pre-emphasis period based on line segment points according to further embodiments of the inventive concept.

FIG. 13 is a view illustrating operations in which a pre-emphasis controller shown in FIG. 5 sets a pre-emphasis level based on line segment points, according to some embodiments of the inventive concept.

FIG. 14 is a flowchart illustrating operations in which a pre-emphasis controller shown in FIG. 5 sets a pre-emphasis period based on active lines according to some embodiments of the inventive concept.

FIG. 15 is a block diagram illustrating a pre-emphasis controller and a third register shown in FIG. 5 according to some embodiments of the inventive concept.

FIGS. 16 and 17 are views illustrating a packet configuration of serial data of FIG. 1 according to some embodiments of the inventive concept.

FIG. 18 is a flowchart illustrating operations in which a pre-emphasis controller processes set data according to some embodiments of the inventive concept.

FIG. 19 is a flowchart illustrating operations in which a pre-emphasis controller processes set data according to some embodiments of the inventive concept.

FIGS. 20 and 21 are circuit diagrams illustrating a gray scale voltage generator of FIG. 5 according to some embodiments of the inventive concept.

FIGS. 22 and 23 are circuit diagrams illustrating a gray scale voltage generator of FIG. 5 according to some embodiments of the inventive concept.

FIGS. 24 and 25 are circuit diagrams illustrating a gray scale voltage generator of FIG. 5 according to some embodiments of the inventive concept.

FIG. 26 is a block diagram illustrating a display device according to further embodiments of the inventive concept.

FIG. 27 is a block diagram illustrating a display device according to further embodiments of the inventive concept.

### DETAILED DESCRIPTION

Embodiments of the inventive concept will be described in detail hereinafter with reference to the accompanying drawings. Like reference numerals may refer to like elements throughout this application. Embodiments of the inventive concept provide a computing system for providing high security and reliability of firmware by using a hardware security module and a firmware managing method thereof.

Some embodiments of the inventive concept stem from a realization that conventional display devices may include a pre-emphasis controller that may be used to increase the magnitude of some pixel data relative to other pixel data to increase the resolution of an image on a display. The pre-emphasis controller may use a look-up table that contains information for performing the pre-emphasis operations. Conventional display devices, however, do not provide a mechanism for dynamically updating information stored in a look-up table for use in performing per-emphasis operations. Embodiments of the present inventive concept may provide a look-up table for use during pre-emphasis operations that can be dynamically updated in accordance with the capabilities of the particular display panel being driven. Moreover, the look-up table may store gamma curve information, which may be used to improve the usage of bits when encoding an image by taking advantage of the non-linear way in which humans perceive light and color.

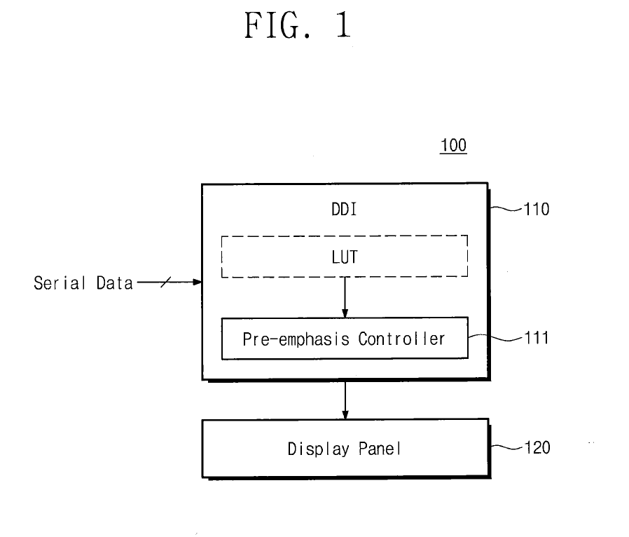

FIG. 1 is a block diagram illustrating a display device according to some embodiments of the inventive concept. Referring to FIG. 1, a display device 100 may include a display driver circuit 110 and a display panel 120. The display driver circuit 110 may also be referred to as a display driver integrated circuit (DDI).

The display driver circuit 110 may include a pre-emphasis controller 111. The pre-emphasis controller 111 may generate pre-emphasis pixel data based on a look-up table LUT. The lookup table LUT may include set data for increasing a resolution of an image to be displayed in the display panel 120. The set data may be values for a pre-emphasis operation. The pre-emphasis controller 111 may drive the display panel 120 based on the pre-emphasis pixel data.

The display panel 120 may display an image in a frame unit. In accordance with various embodiments, the display panel 120 may be implemented with a liquid crystal display (LCD) panel, a light emitting diode (LED) display panel, an organic LED (OLED) panel, an active-matrix OLED (AMOLED) display panel, a flexible display panel, or the like. Alternatively, the display panel 120 may be implemented with a flat display panel different from the above-described display panels.

According to an embodiment of the inventive concept, the display driver circuit 110 may receive the set data and pixel data in the form of serial data. The set data included in the lookup table LUT may be based on the specifications or performance of the display panel 120. Accordingly, the pre-emphasis pixel data may be generated according to the specifications or performance of the display panel 120. Below, a configuration of the display device 100, according to some embodiments, will be more fully described.

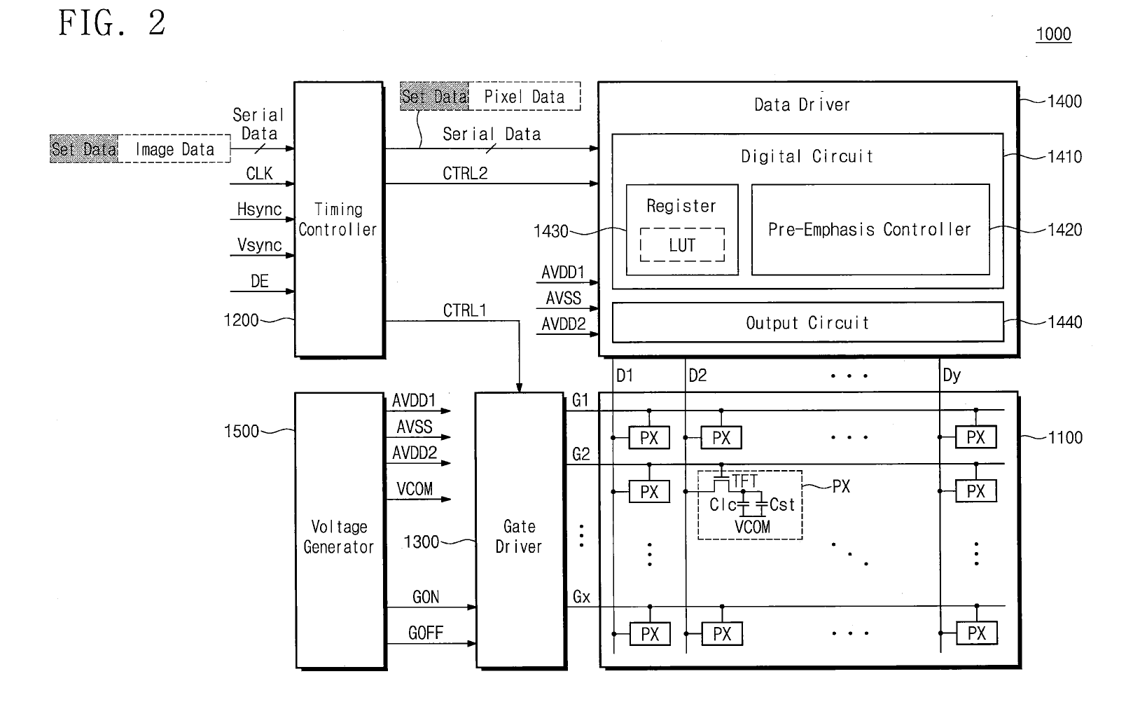

FIG. 2 is a block diagram illustrating a display device of FIG. 1 according to some embodiments of the inventive concept. Referring to FIG. 2, a display device 1000 may include a display panel 1100, a timing controller 1200, a gate driver 1300, a data driver 1400, and a voltage generator 1500. Each of the timing controller 1200, the gate driver 1300, and the data driver 1400 may be a circuit for driving the display panel 1100. In particular, the data driver 1400 may be the display driver circuit 110 of FIG. 1, or a circuit in which the timing controller 1200 and the data driver 1400 are integrated may be the display driver circuit 110 of FIG. 1. The functionality of various modules described herein may be combined into fewer circuits or modules or divided into additional circuits or modules in accordance with various embodiments of the inventive concept.

The display panel 1100 may include a plurality of gate lines G1 to Gx arranged in a row direction, a plurality of data lines D1 to Dy arranged in a column direction, and a plurality of pixels arranged at intersections of the plurality of gate lines G1 to Gx and the plurality of data lines D1 to Dy. Here, “x” and “y” are a natural number. As illustrated in FIG. 2, one pixel PX may include a thin film transistor TFT, and a liquid crystal capacitor Clc and a storage capacitor Cst connected to a drain electrode of the thin film transistor TFT. If any gate line is selected, the thin film transistor TFT of a pixel connected to the selected gate line may be turned on. Afterwards, a gray scale voltage corresponding to pixel data may be applied to the liquid crystal capacitor Clc and the storage capacitor Cst. The display panel 1100 may be the display panel 120 of FIG. 1.

The timing controller 1200 may receive control signals from an external device (e.g., a host, an application processor, or the like). The control signals may include, for example, a clock CLK, a horizontal synchronization signal Hsync, a vertical synchronization signal Vsync, and a data enable signal DE. The timing controller 1200 may generate first and second control signals CTRL1 and CTRL2 for respectively controlling the gate driver 1300 and data driver 1400 by using the clock CLK, the horizontal synchronization signal Hsync, the vertical synchronization signal Vsync, and the data enable signal DE.

The timing controller 1200 may receive serial data including set data and image data. In more detail, the timing controller 1200 may receive the set data and the image data through the same data terminal (not illustrated). The set data may be stored in a register 1430. The set data may include information for controlling the pre-emphasis operation. The set data may be transmitted to the timing controller 1200 through a serial interface that receives the image data.

The timing controller 1200 may transmit the set data and the pixel data to the data driver 1400 in a form similar to the received serial data. The timing controller 1200 may transmit the received set data to the data driver 1400 without modification. The timing controller 1200 may change the image data to pixel data and may transmit the pixel data to the data driver 1400. The data driver 1400 may be configured according to the specifications of the display panel 1100. As illustrated in FIG. 2, serial data may be transmitted from the timing controller 1200 to the data driver 1400.

The gate driver 1300 may drive the plurality of gate lines G1 to Gx of the display panel 1100 based on the first control signal CTRL1. The gate driver 1300 may sequentially select the plurality of gate lines G1 to Gx by applying a gate-on voltage GON. A gate-off voltage GOFF may be applied to unselected gate lines. A gray scale voltage may be applied to activated pixels connected to a selected gate line by the data driver 1400.

The data driver 1400 may receive serial data including the set data and the pixel data from the timing controller 1200. In some embodiments, the data driver 1400 may receive serial data from an external device as well as the timing controller 1200. Similar to the timing controller 1200, the data driver 1400 may receive the set data and the pixel data through the same data terminal (not illustrated). That is, the set data may be transmitted to the register 1430 of the data driver 1400 through a serial interface that receives the pixel data.

The data driver 1400 may drive the plurality of data lines D1 to Dy of the display panel 1100 based on the second control signal CTRL2. The data driver 1400 may include a digital circuit 1410 and an output circuit 1440. The digital circuit 1410 may receive and store the pixel data from the timing controller 1200. For example, the pixel data may be RGB data.

According to some embodiments of the inventive concept, the digital circuit 1410 may include a pre-emphasis controller 1420 and the register 1430. The pre-emphasis controller 1420 may generate pre-emphasis pixel data based on the pixel data and the information in the look-up table LUT stored in the register 1430. The pre-emphasis controller 1420 may control a pre-emphasis operation for providing the pre-emphasis pixel data to the output circuit 1440 and adjusting a slew rate of a gray scale voltage to be applied to a pixel PX.

The output circuit 1440 may output gray scale voltages to pixels through the plurality of data lines D1 to Dy. For example, the output circuit 1440 may output a target gray scale voltage corresponding to the pixel data and a pre-emphasis gray scale voltage corresponding to the pre-emphasis pixel data to a pixel. The target gray scale voltage indicates a gray scale voltage corresponding to the pixel data transmitted to the data driver 1400.

The voltage generator 1500 may supply power to the display panel 1100, the timing controller 1200, the gate driver 1300, and the data driver 1400. The voltage generator 1500 may generate the gate-on voltage VON, the gate-off voltage GOFF, a first power voltage AVDD1, a second power voltage AVSS, a third power voltage AVDD2, and a common voltage VCOM. The gate-on voltage VON and the gate-off voltage GOFF may be supplied to the gate driver 1300, the common voltage VCOM may be supplied in common to pixels PX, and the first power voltage AVDD1, the second power voltage AVSS, and the third power voltage AVDD2 may be supplied to the data driver 1400.

In some embodiments, the timing controller 1200, the gate driver 1300, the data driver 1400, and the voltage generator 1500 may be implemented in one integrated circuit (IC). In other embodiments, the timing controller 1200, the gate driver 1300, the data driver 1400, and the voltage generator 1500 may be respectively implemented with separated integrated circuits. Thus, functionality provided by the timing controller 1200, gate driver 1300, data driver 1400, and voltage generator 1500 may provided using one ID or divided among multiple ICs in accordance with various embodiments of the inventive concept.

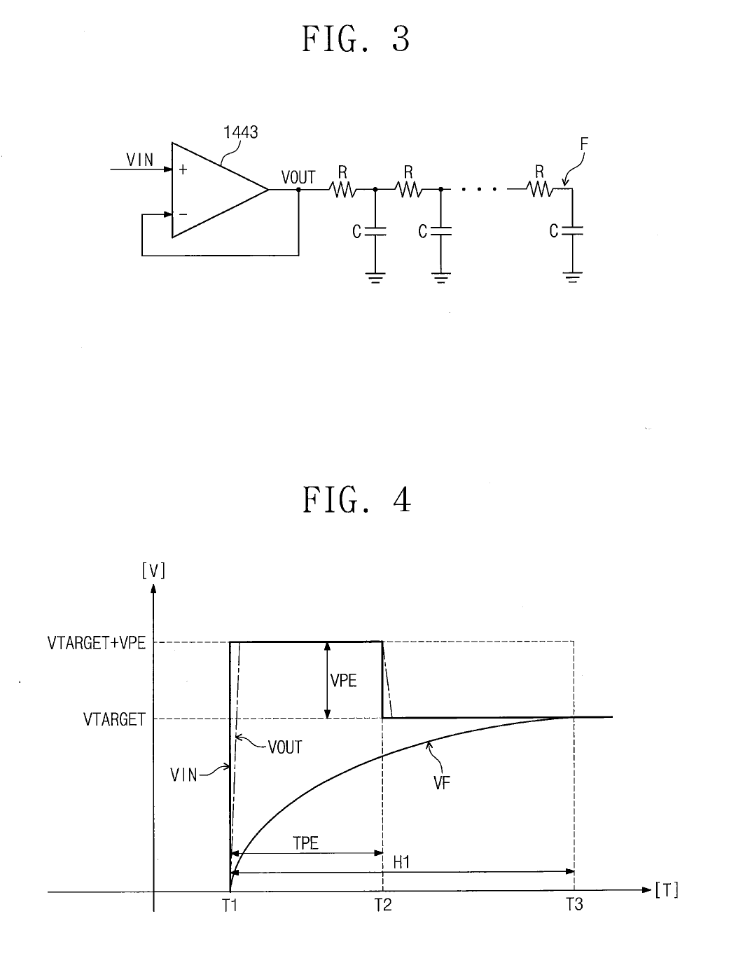

FIG. 3 is a circuit diagram in which an output circuit illustrated in FIG. 2 and pixels and a data line connected to the output circuit are modeled according to some embodiments of the inventive concept. The output circuit 1440 may include at least one amplifier 1443. For example, the amplifier 1443 may be an operational amplifier. The amplifier 1443 may drive pixels through a data line. The amplifier 1443 may receive an input voltage VIN through a non-inverting terminal and output the input voltage VIN. The input voltage VIN may be a voltage provided to the amplifier 1443 for outputting a gray scale voltage to a pixel. An output voltage VOUT may be output to a pixel through a data line. The output voltage VOUT may be provided to an inverting terminal of the amplifier 1443. The amplifier 1443 may operate as a buffer.

Referring to FIG. 3, a load of the amplifier 1443 may be modeled as resistors “R” and capacitors “C”. The “R” and “C’ values may be determined based on a width and a length of the data line, the size of a thin film transistor TFT, and the like. The amplifier 1443 may drive both a pixel close to the amplifier 1443 and a pixel (e.g., an “F” node) distant from the amplifier 1443. In particular, in the case where the amplifier 1443 drives a pixel distant from the amplifier 1443, a pre-emphasis operation may be used.

FIG. 4 is a timing diagram illustrating operations of an amplifier shown in FIG. 3. FIG. 4 will be described with reference to FIGS. 2 and 3. In FIG. 4, a horizontal axis represents time, and a vertical axis represents voltage. The input voltage VIN, the output voltage VOUT, and a voltage VF of the “F” node are illustrated in FIG. 4.

In some embodiments, the voltage VF of the “F” node may reach a target gray scale voltage VTARGET within a horizontal period H1 (from T1 to T3). The horizontal period H1 may be determined based on the specifications, power consumption, an operating speed, etc. of the display panel 1100. If the voltage VF of the “F” node exceeds the target gray scale voltage VTARGET or does not reach the target gray scale voltage VTARGET, the image quality of the display panel 1100 may decrease. For driving the voltage VF of the “F” node to the target gray scale voltage VTARGET within the horizontal period H1, the data driver 1400 may generate an input voltage higher than a target voltage during an initial period (over driving). In more detail, the input voltage may be “VTARGET+VPE” during a pre-emphasis period TPE (from T1 to T2) and may be “VTARGET” after the pre-emphasis period. The gray scale voltage of “VTARGET+VPE” corresponds to pre-emphasis pixel data, and the gray scale voltage of “VTARGET” corresponds to pixel data transmitted to the data driver 1400. “VPE” is a pre-emphasis level.

According to some embodiments of the inventive concept, the data driver 1400 may adjust the pre-emphasis level VPE and the pre-emphasis period TPE appropriately. The pre-emphasis level VPE and the pre-emphasis period TPE may be adjusted based on a location of each pixel PX and the target gray scale voltage VTARGET. Below, a structure and pre-emphasis operations of the data driver 1400, according to some embodiments, will be more fully described.

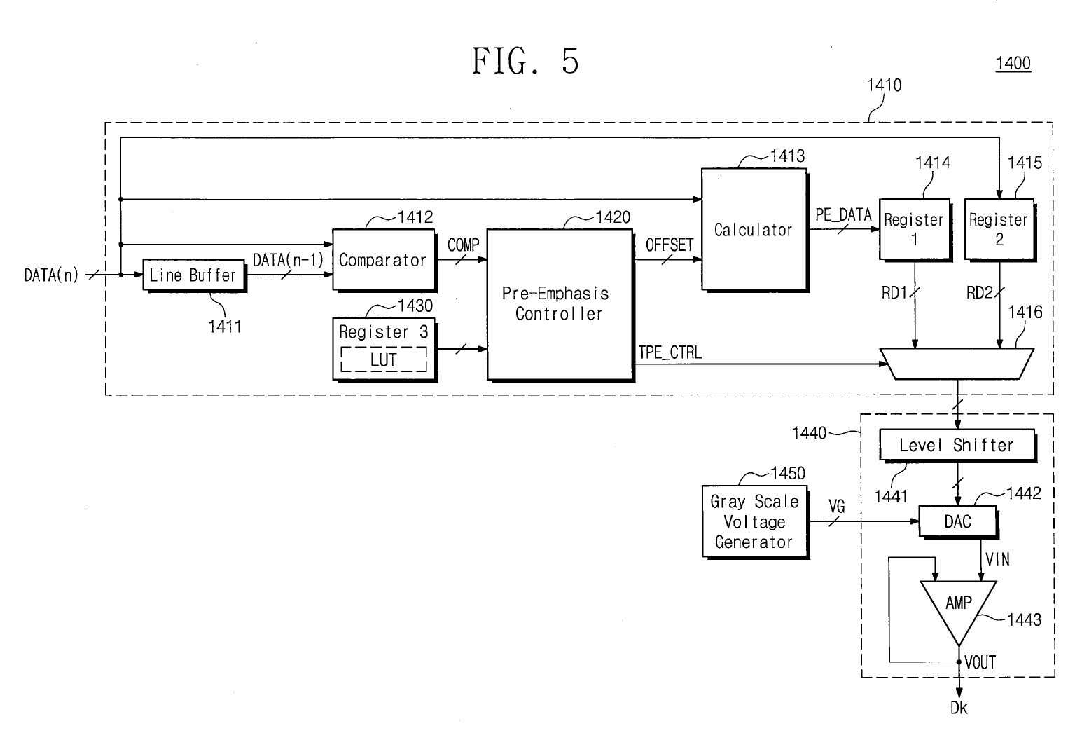

FIG. 5 is a block diagram illustrating a data decoder shown in FIG. 2 according to some embodiments of the inventive concept. The data driver 1400 may include the digital circuit 1410, the output circuit 1440, and a gray scale voltage generator 1450.

The digital circuit 1410 may include a line buffer 1411, a comparator 1412, a calculator 1413, first and second registers 1414 and 1415, a multiplexer 1416, the pre-emphasis controller 1420, and the third register 1430.

The line buffer 1411 may store second pixel data DATA(n). If the line buffer 1411 receives the second pixel data DATA(n), data previously stored in the line buffer 1411 may be first pixel data DATA(n−1). The second pixel data DATA(n) may be updated when pixel data are transmitted to the data driver 1400. Here, “n” may indicate an order or the number of times of pixel data are provided to the digital circuit 1410. For example, the line buffer 1411 may be a single port static random access memory (SPSRAM) or a shift register.

The comparator 1412 may compare the first pixel data DATA(n−1) with the second pixel data DATA(n). Below, for convenience of description, the first pixel data DATA(n−1) is referred to as “previous pixel data DATA(n−1)”, and the second pixel data DATA(n) is referred to as “current pixel data DATA(n)”. Also, a first pixel provided with the first pixel data DATA(n−1) is referred to as a “previous pixel”, and a second pixel provided with the second pixel data DATA(n) is referred to as a “current pixel”. The previous pixel data DATA(n−1) and the current pixel data DATA(n) may be respectively output to the previous pixel and the current pixel through one data line Dk. The comparator 1412 may provide the compare result COMP to the pre-emphasis controller 1420.

The calculator 1413 may calculate pre-emphasis pixel data PE_DATA based on the current pixel data DATA(n) and an offset. The offset may be calculated by the pre-emphasis controller 1420. The calculator 1413 may add the offset to the current pixel data DATA(n) or may subtract the offset from the current pixel data DATA(n). For example, the calculator 1413 may include an adder and a subtractor.

The magnitude of the pre-emphasis pixel data PE_DATA may be greater than the magnitude of the current pixel data DATA(n). In some embodiments, if the current pixel data DATA(n) are 10 bits, the pre-emphasis pixel data PE_DATA may be 11 bits (1-bit expansion). The number of bits of the pre-emphasis pixel data PE_DATA may be more than the number of bits of the current pixel data DATA(n). Through the bit expansion, the pre-emphasis pixel data PE_DATA may include a value obtained by adding an offset to the maximum current pixel data DATA(n) or a value obtained by subtracting an offset from the minimum current pixel data DATA(n). The above-described numerical values all may be examples to illustrate embodiments of the inventive concept.

The first register 1414 may store the pre-emphasis pixel data PE_DATA, and the second register 1415 may store the current pixel data DATA(n). Each of the first and second registers 1414 and 1415 may be implemented with an SPSRAM or a shift register. Due to the above-described bit expansion, the size of the first register 1414 may be larger than the size of the second register 1415.

The multiplexer 1416 may select one of first register data RD1 or second register data RD2 based on a pre-emphasis period control signal TPE_CTRL of the pre-emphasis controller 1420. If the first register data RD1 are selected, the output circuit 1440 may output a pre-emphasis gray scale voltage corresponding to pre-emphasis pixel data to a current pixel. If the second register data RD2 are selected, the output circuit 1440 may output a target gray scale voltage corresponding to the current pixel data DATA(n) to the current pixel.

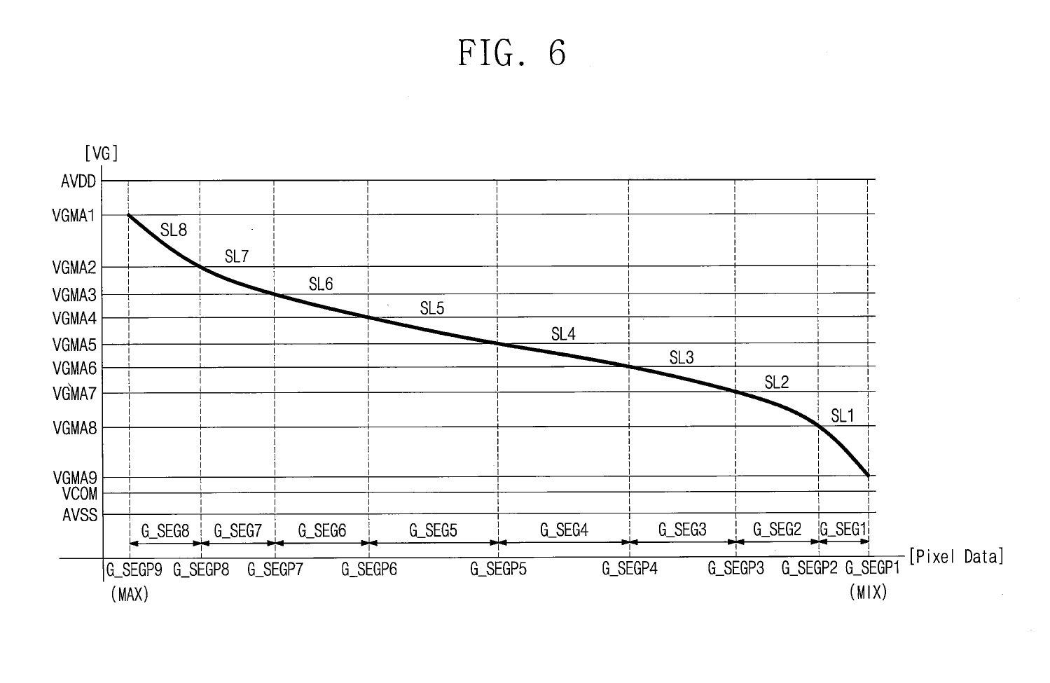

The pre-emphasis controller 1420 may calculate the offset based on the compare result COMP and the look-up table LUT information stored in the third register 1430. The pre-emphasis controller 1420 may generate the pre-emphasis period control signal TPE_CTRL in consideration of distances between the output circuit 1440 and pixels. The pre-emphasis controller 1420 may operate in a digital manner. A configuration and an operation of the pre-emphasis controller 1420, according to some embodiments of the inventive concept, will be more fully described with reference to FIGS. 6 to 15.

The third register 1430 may store the lookup table LUT including information that is needed for the pre-emphasis controller 1420 to generate an offset. The third register 1430 may include a volatile memory such as a dynamic random access memory (DRAM), a static random access memory (SRAM), or the like or a nonvolatile memory such as a NAND flash memory, a NOR flash memory, a ferroelectric random access memory (FRAM), a phase change random access memory (PRAM), a thyristor random access memory (TRAM), a resistive random access memory (ReRAM), a magnetic random access memory (MRAM), or the like. Thus, the third register 1430 may include one or more volatile memories, nonvolatile memories, and/or combinations thereof. In other embodiments, the third register 1430 may be included in the pre-emphasis controller 1420.

The output circuit 1440 may include a level shifter 1441, a digital to analog converter 1442, and the amplifier 1443.

The level shifter 1441 may convert voltage levels of the first register data RD1 and the second register data RD2. The first register data RD1 and the second register data RD2 are provided from the digital circuit 1410 to the output circuit 1440 being an analog circuit. Accordingly, the level shifter 1441 may convert voltage levels of the first register data RD1 and the second register data RD2 based on an operating environment (e.g., supply voltages, kind of transistor, or the like) of the output circuit 1440.

The digital to analog converter 1442 may receive the first register data RD1 and the second register data RD2 and may select one of a plurality of gray scale voltages VG. The digital to analog converter 1442 may select one from gray scale voltages higher than a gray scale voltage corresponding to a maximum value of pixel data and gray scale voltages lower than a gray scale voltage corresponding to a minimum value of the pixel data.

The amplifier 1443 may be provided with the input voltage VIN (i.e., a gray scale voltage) from the digital to analog converter 1442 and may output the input voltage VIN to a k-th data line Dk. The k-th data line Dk may be any one of the plurality of data lines D1 to Dy of FIG. 1 (k being a natural number). One amplifier 1443 and one output circuit 1440 including the amplifier 1443 are illustrated in FIG. 5. However, the number of amplifiers and the number of output circuits may be determined according to the number of data lines in accordance with various embodiments of the inventive concept.

The gray scale voltage generator 1450 generates the plurality of gray scale voltages VG corresponding to a gray scale that pixel data indicates. For example, in the case where pixel data are 10-bit data, the gray scale voltage generator 1450 may generate 1024 (=2¹⁰) gray scale voltages VG. Also, for a pre-emphasis operation, the gray scale voltage generator 1450 may further generate gray scale voltages higher than a gray scale voltage corresponding to a maximum value of pixel data and may further generate gray scale voltages lower than a gray scale voltage corresponding to a minimum value of the pixel data.

FIG. 6 is a view illustrating a gamma curve of pixel data versus a gray scale voltage according to some embodiments of the inventive concept. In FIG. 6, a horizontal axis represents pixel data, and a vertical axis represents a gray scale voltage. A variation of pixel data and a variation of a gray scale voltage may not be exactly proportional. As illustrated in FIG. 6, a gamma curve may be nonlinear. Accordingly, the pre-emphasis controller 1420 may determine a pre-emphasis level VPE (refer to FIG. 4) in consideration of the nonlinearity of a gamma curve. To this end, information about the gamma curve may be stored in the third register 1430.

However, if gray scale voltages associated with values of all pixel data are stored in the third register 1430, the amount of information stored in the third register 1430 may be relatively large. For example, if pixel data are 10-bit data, data of a 2¹⁰×2¹⁰ size may be stored in the third register 1430. This approach may be inefficient because the amount of information stored in the third register is proportional to the square of a pixel data size. According to some embodiments of the inventive concept, the third register 1430 may not store information about all gray scale voltages corresponding to pixel data, but may store a plurality of gamma segment points G_SEGP1 to G_SEGP9 used as a reference (or a criterion) for dividing pixel data.

A plurality of gamma segment points G_SEGP1 to G_SEGP9 and a plurality of gamma segments G_SEG1 to G_SEG8 are illustrated in FIG. 6. The plurality of gamma segments G_SEG1 to G_SEG8 may be determined according to locations of the plurality of gamma segment points G_SEGP1 to G_SEGP9. Pixel data existing between the first gamma segment point G_SEGP1 and the second gamma segment point G_SEGP2 may be included in the first gamma segment G_SEG1. Pixel data existing between other gamma segments G_SEG2 to G_SEG8 may be divided in a manner similar to the above-described manner.

A partial gamma curve corresponding to each of the plurality of gamma segments G_SEG1 to G_SEG8 may be linear compared with the whole gamma curve. Accordingly, assuming that a gamma curve corresponding to a gamma segment is linear, the third register 1430 may store a plurality of slope values SL1 to SL8 instead of storing information about all gray scale voltages corresponding to pixel data. The plurality slope values SL1 to SL8 may be respective ratios of a plurality of gray scale voltage ranges to the plurality of gamma segments G_SEG1 to G_SEG8. As illustrated in FIG. 6, a first gray scale voltage range among a plurality of gray scale voltage ranges represents a range defined by an eighth reference voltage VGMA8 and a ninth reference voltage VGMA9. Second to ninth gray scale voltage ranges may be determined in a manner similar to the first gray scale voltage range.

In some embodiments, the first slope value SL1 may be a gamma curve slope of an intermediate point between the first gamma segment point G_SEGP1 and the second gamma segment point G_SEGP2. In other embodiments, the first slope value SL1 may be a ratio of a difference between a first reference voltage VGMA1 and a second reference voltage VGMA2 to a difference between the first gamma segment point G_SEGP1 and the second gamma segment point G_SEGP2. Other slope values SL2 to SL8 may be determined in a manner similar to the above-described manner.

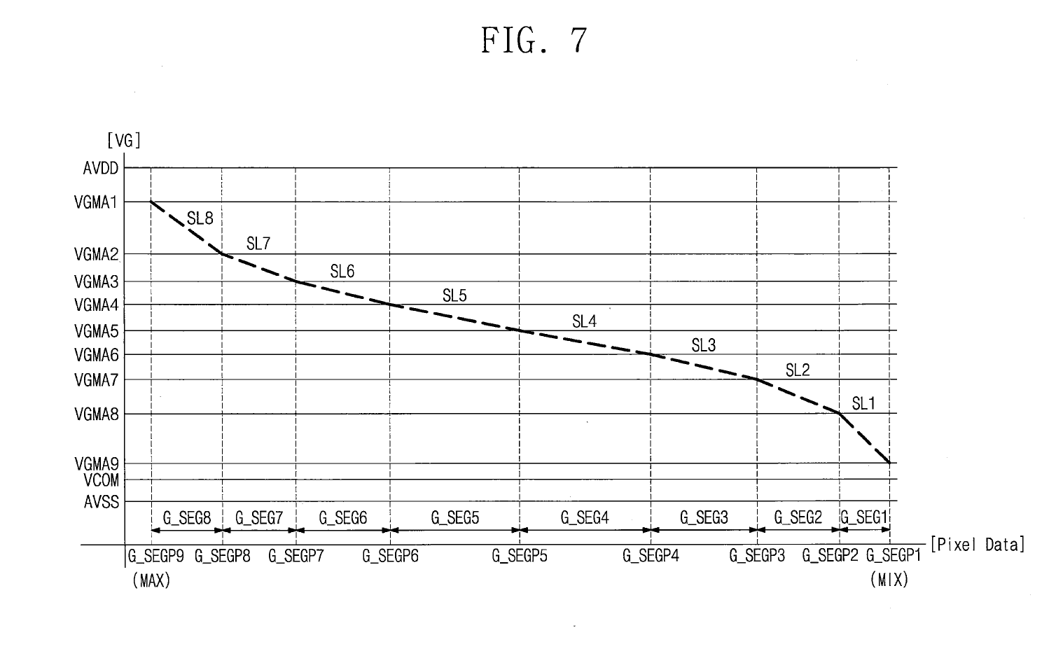

Referring to FIG. 6, the plurality of gamma segment points G_SEGP1 to G_SEGP9 may correspond to the plurality of gamma segments VGMA1 to VGMA9, respectively. The plurality of reference voltages VGMA1 to VGMA9 may be used as reference voltages in the above-described gray scale voltage generator 1450. A result of linearizing the gamma curve of FIG. 6 is illustrated in FIG. 7.

FIG. 7 is a view illustrating a gamma curve linearized by gamma segment points according to some embodiments of the inventive concept. A gamma curve of FIG. 6 is marked by a solid line, and a gamma curve of FIG. 7 is marked by a dotted line. The number of gamma segment points G_SEGP1 to G_SEGP9 is not limited to those shown in FIGS. 6 and 7. Also, locations of the gamma segment points G_SEGP1 to G_SEGP9 may be changed by set data that a host or an AP provides. Also, the plurality of reference voltages VGMA1 to VGMA9 may be determined according to locations of the plurality of gamma segment points G_SEGP1 to G_SEGP9.

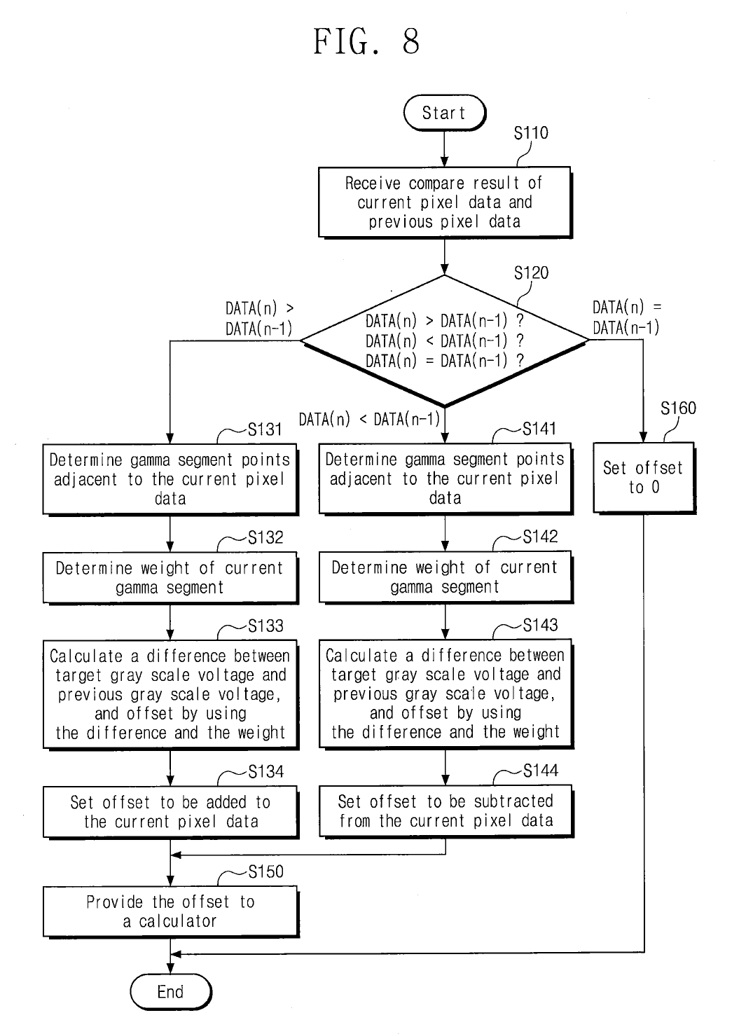

FIG. 8 is a flowchart illustrating operations in which a pre-emphasis controller illustrated in FIG. 5 generates an offset according to some embodiments of the inventive concept. The flowchart illustrates operations in which a pre-emphasis controller illustrated in FIG. 5 generates an offset. FIG. 8 will be described with reference to FIGS. 2 and 5 to 7.

In operation S110, the pre-emphasis controller 1420 may receive a compare result COMP of the previous pixel data DATA(n−1) and the current pixel data DATA(n) by the comparator 1412. The comparator 1412 may compare the previous pixel data DATA(n−1) (i.e., first pixel data) output from the output circuit 1440 to a first pixel through a k-th data line Dk with the current pixel data DATA(n) (i.e., second pixel data) to be output from the output circuit 1440 to a second pixel through the k-th data line Dk.

In operation S120, if the current pixel data DATA(n) is greater than the previous pixel data DATA(n−1), the pre-emphasis controller 1420 may perform operation S131 to operation S134. If the current pixel data DATA(n) is less than the previous pixel data DATA(n−1), the pre-emphasis controller 1420 may perform operation S141 to operation S144. If the current pixel data DATA(n) is the same as the previous pixel data DATA(n−1), the pre-emphasis controller 1420 may perform operation S160.

In operation S131, the pre-emphasis controller 1420 may determine gamma segment points adjacent to the current pixel data DATA(n) among the plurality of gamma segment points G_SEGP1 to G_SEGP9. The pre-emphasis controller 1420 may determine a current gamma segment, which the current pixel data DATA(n) belong to, from among the plurality of gamma segments G_SEG1 to G_SEG8.

In operation S132, the pre-emphasis controller 1420 may determine a weight of the current gamma segment. The weight may indicate a difference between a target gray scale voltage corresponding to the current pixel data DATA(n) and a previous gray scale voltage corresponding to the previous pixel data DATA(n−1) is emphasized. For example, the weight may be a value that is based on a difference between a target gray scale voltage and a previous gray scale voltage. In more detail, the weight may be a ratio of a gray scale voltage (refer to VPE of FIG. 4) corresponding to an offset to a difference between a target gray scale voltage and a previous gray scale voltage.

In operation S133, the pre-emphasis controller 1420 may calculate an offset to be added to the current pixel data DATA(n). First, the pre-emphasis controller 1420 may calculate a difference between a target gray scale voltage and a previous gray scale voltage by using the compare result of operation S110 and at least one of the plurality of slope values SL1 to SL8. In some embodiments, if the current pixel data DATA(n) and the previous pixel data DATA(n−1) belong to the same gamma segment, only one slope value of the corresponding gamma segment may be used. In other embodiments, if a gamma segment that the current pixel data DATA(n) belong to is different from a gamma segment that the previous pixel data DATA(n−1) belong to, two or more slope values may be used.

The pre-emphasis controller 1420 may generate an offset by using the difference determined in operation S133 and at least one of a plurality of weights. In some embodiments, it is assumed that a gamma segment of the previous pixel data DATA(n−1) is a fourth gamma segment G_SEG4 and a gamma segment of the current pixel data DATA(n) is a seventh gamma segment G_SEG7.

The pre-emphasis controller 1420 may calculate a difference between a target gray scale voltage corresponding to the current pixel data DATA(n) and a previous gray scale voltage corresponding to the previous pixel data DATA(n−1) by using the fourth to seventh slope values SL4 to SL7. The pre-emphasis controller 1420 may calculate an offset by using the calculated difference and a weight value of the seventh gamma segment G_SEG7. The current pixel data DATA(n) may be included in the seventh gamma segment G_SEG7, and a value of the current pixel data DATA(n) plus the offset may also be included in the seventh gamma segment G_SEG7. However, the value of the current pixel data DATA(n) plus the offset may be included in the eighth gamma segment G_SEG8. Accordingly, the pre-emphasis controller 1420 may calculate or generate an offset with reference to a slope value SL8 of an adjacent gamma segment (the eighth gamma segment G_SEG8) as well as a slope value SL7 of the seventh gamma segment G_SEG7. In some embodiments, the number of adjacent gamma segments may be one or more.

To sum up operation S131 to operation S133, the pre-emphasis controller 1420 may calculate an offset based on gamma segment points adjacent to the current pixel data DATA(n) and the compare result of the comparator 1412. In more detail, the pre-emphasis controller 1420 may calculate an offset by using at least one of a plurality of slope values and at least one of a plurality of weights.

In operation S134, the pre-emphasis controller 1420 may set the calculator 1413 such that the offset calculated in operation S133 is added to the current pixel data DATA(n) depending on the compare result of the comparator 1412. The pre-emphasis controller 1420 may activate an adder included in the calculator 1413. In other embodiments, the pre-emphasis controller 1420 may set a most significant bit of the offset to “1” or “0”. For example, if the most significant bit is “1”, the calculator 1413 may perform an addition operation; if the most significant bit is “0”, the calculator 1413 may perform a subtraction operation. However, the above-described numerical values are examples and do not limit the scope and spirit of embodiments of the inventive concept.

Operation S141 to operation S143 may be substantially similar to operation S131 to operation S133. Because the current pixel data DATA(n) is less than the previous pixel data DATA(n−1), in operation S144, the pre-emphasis controller 1420 may set the calculator 1413 or the most significant bit of the offset, such that the offset calculated in operation S143 is subtracted from the current pixel data DATA(n).

In operation S150, the pre-emphasis controller 1420 may provide the calculator 1413 with the offset calculated through operation S131 to S134 or through operation S141 to operation S144. The calculator 1413 may calculate pre-emphasis pixel data based on the offset and the current pixel data DATA(n). If the current pixel data DATA(n) is greater than the previous pixel data DATA(n−1), the calculator 1413 may calculate pre-emphasis pixel data by adding the offset to the current pixel data DATA(n). If the current pixel data DATA(n) is less than the previous pixel data DATA(n−1), the calculator 1413 may calculate pre-emphasis pixel data by subtracting the offset from the current pixel data DATA(n).

In operation S160, the current pixel data DATA(n) is the same as the previous pixel data DATA(n−1). In this case, because there is no need for a pre-emphasis operation, the pre-emphasis controller 1420 may set the offset to “0”. That is, the calculator 1413 may calculate the current pixel data DATA(n) as pre-emphasis pixel data PE_DATA without modification.

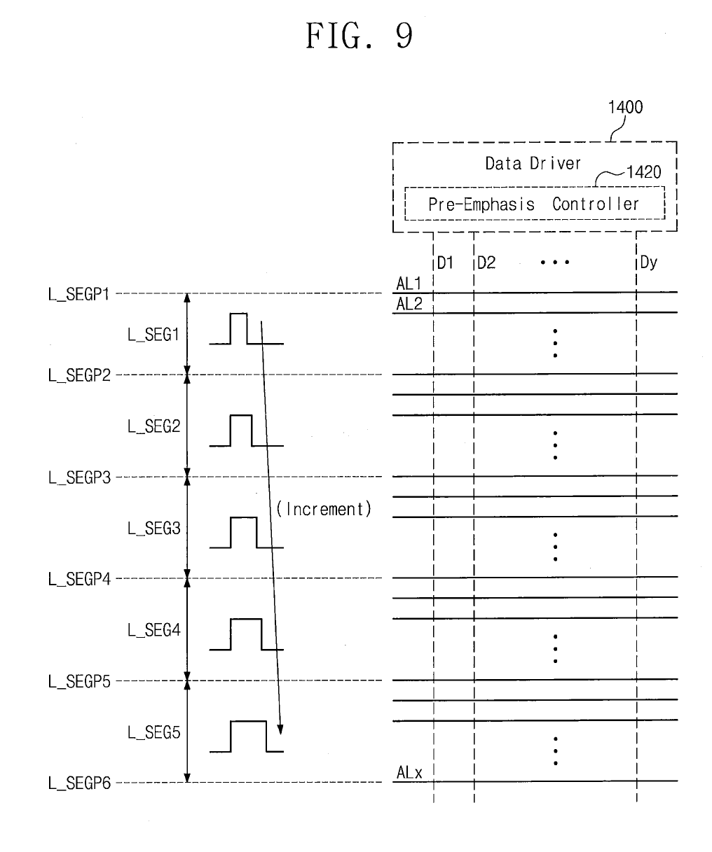

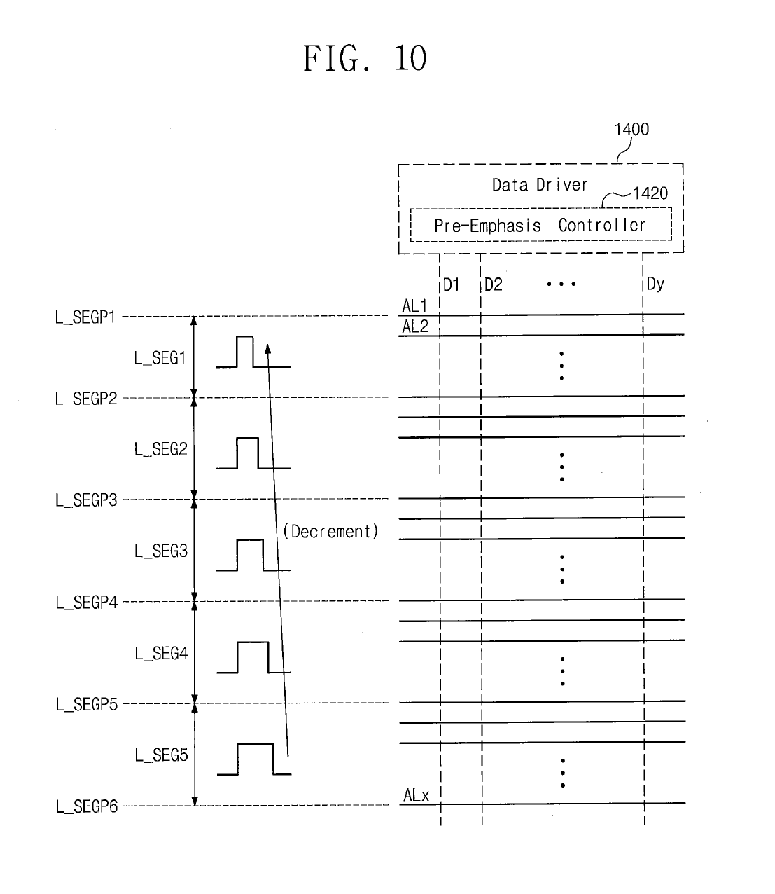

FIGS. 9 and 10 are views illustrating operations in which a pre-emphasis controller illustrated in FIG. 5 sets a pre-emphasis period based on line segment points, according to some embodiments of the inventive concept. FIGS. 9 and 10 will be described with reference to FIGS. 2 and 5. Referring to FIGS. 9 and 10, there are illustrated a plurality of active lines AL1 to ALx, a plurality of data lines D1 to Dy crossing the plurality of active lines AL1 to ALx, and the data driver 1400 driving the plurality of data lines D1 to Dy. The plurality of active lines AL1 to ALx may respectively correspond to pixels connected to a gate line selected by the gate driver 1300 of FIG. 1.

The gate driver 1300 of FIG. 1 may sequentially select the plurality of gate lines G1 to Gx. Here, it is assumed that the data driver 1400 of FIG. 9 sequentially transmits pixel data from an active line close thereto to an active line distant therefrom, and it is assumed that the data driver 1400 of FIG. 10 sequentially transmits pixel data from an active line distant therefrom to an active line close thereto. The first active line AL1 (i.e., pixels connected with the first gate line G1) may be the closest to the output circuit 1440 (refer to FIG. 5) of the data driver 1400, and the x-th active line ALx (i.e., pixels connected with the x-th gate line Gx) may be the farthest from the output circuit 1440 (refer to FIG. 5) of the data driver 1400.

The pre-emphasis controller 1420 may adjust the pre-emphasis period TPE based on a location of an active line. The pre-emphasis controller 1420 of FIG. 9 may increase the pre-emphasis period TPE for a current pixel based on a distance between the current pixel and the output circuit 1440. In contrast, the pre-emphasis controller 1420 of FIG. 10 may decrease the pre-emphasis period TPE for a current pixel based on a distance between the current pixel and the output circuit 1440.

In more detail, the plurality of active lines AL1 to ALx may be divided into a plurality of line segments L_SEG1 to L_SEG5. From the point of view of pixels, a plurality of line segment points L_SEGP1 to L_SEGP6 may be used as a reference for dividing a plurality of pixels, which include a previous pixel and a current pixel and are connected through one data line, into the plurality of line segments L_SEG1 to L_SEG5. The plurality of line segments L_SEG1 to L_SEG5 may be determined according to locations of the plurality of line segment points L_SEGP1 to L_SEGP6. The number of line segment points L_SEGP1 to L_SEGP6 and the number of line segments L_SEG1 to L_SEG5 are examples and different numbers may be used in various embodiments of the inventive concept.

The pre-emphasis controller 1420 may calculate an offset based on the compare result of the comparator 1412 and may adjust a period (i.e., the pre-emphasis period TPE), during which an offset (or pre-emphasis pixel data obtained by adding or subtracting an offset from a current pixel data) is output to a current pixel, based on line segment points adjacent to the current pixel among the plurality of line segment points L_SEGP1 to L_SEGP6.

In more detail, the pre-emphasis controller 1420 may set the pre-emphasis period TPE with the narrowest width with respect to an active line belonging to the first line segment L_SEG1 and may set the pre-emphasis period TPE with the widest width with respect to an active line belonging to the fifth line segment L_SEG5. That is, the pre-emphasis controller 1420 may set the pre-emphasis period TPE in proportion to a distance between a current pixel and the output circuit 1440. Afterwards, the output circuit 1440 may output current pixel data and an offset to a current pixel based on a period adjusted by the pre-emphasis controller 1420.

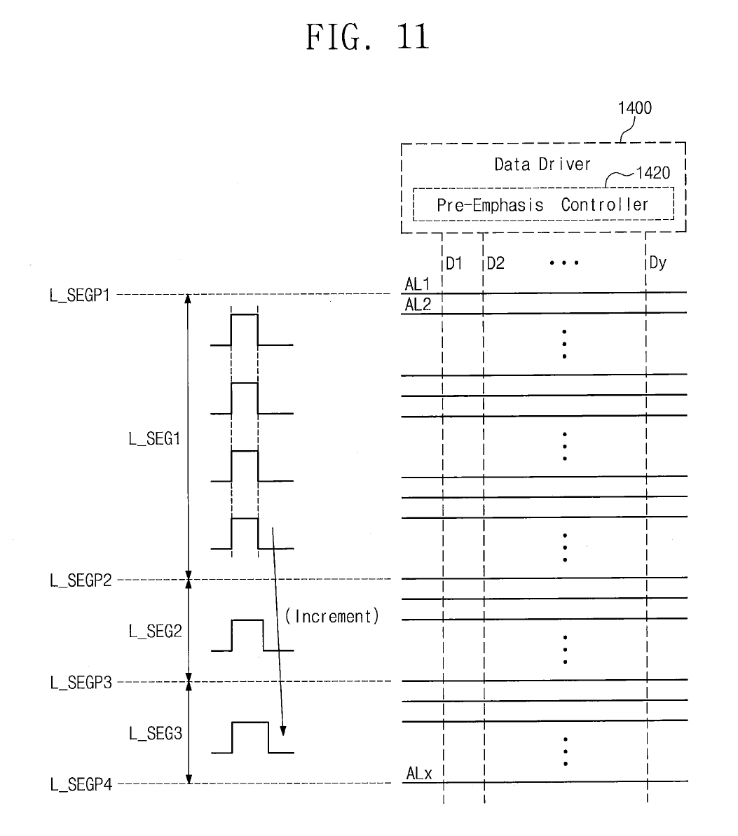

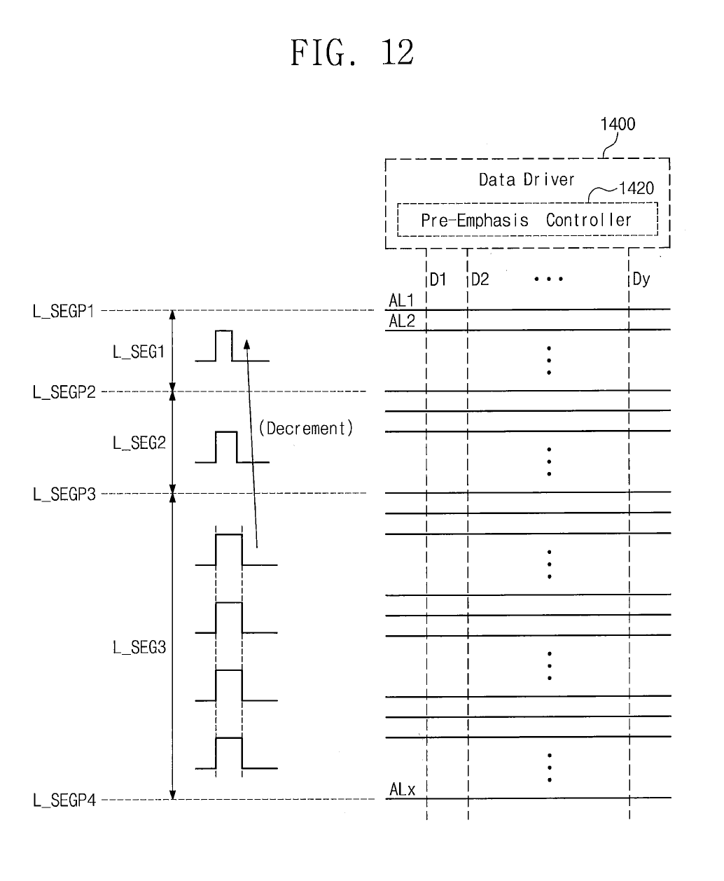

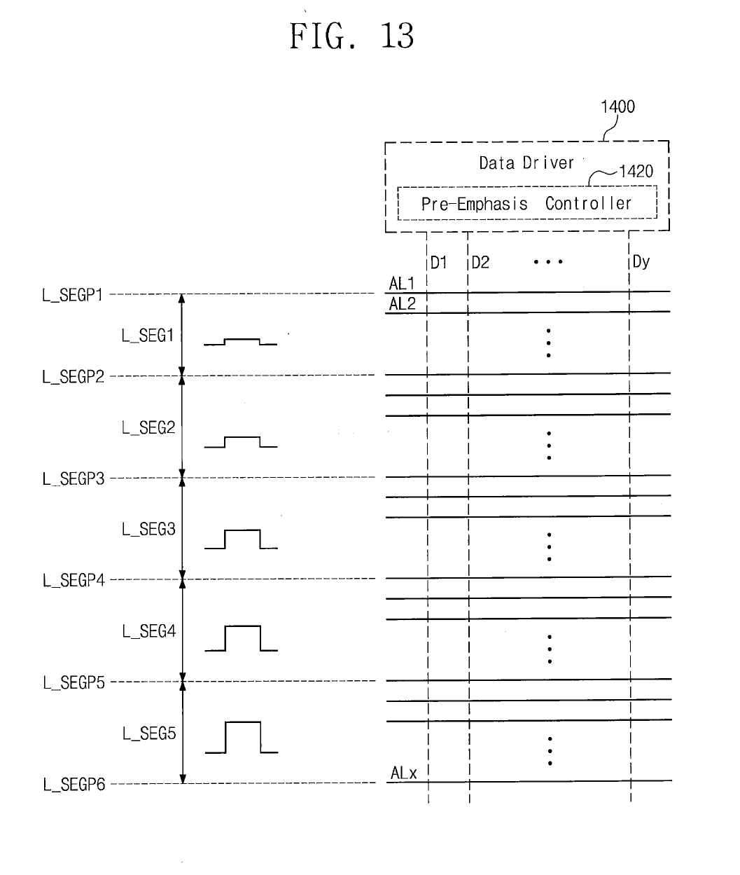

An example is illustrated in FIGS. 9 and 10 as the sizes of line segments L_SEG1˜L_SEG5 are the same as each other, but the scope and spirit of embodiments of the inventive concept are not limited thereto. This will be more fully described with reference to FIGS. 11 and 12.

FIGS. 11 and 12 are views illustrating operations in which a pre-emphasis controller shown in FIG. 5 sets a pre-emphasis period based on line segment points, according to further embodiments of the inventive concept. It is assumed that the data driver 1400 of FIG. 11 sequentially transmits pixel data from an active line close thereto to an active line distant therefrom, and it is assumed that the data driver 1400 of FIG. 12 sequentially transmits pixel data from an active line distant therefrom to an active line close thereto

Referring to FIG. 11, the first line segment L_SEG1 may be set to be greater than the second and third line segments L_SEG2 and L_SEG3. The pre-emphasis controller 1420 may set the same pre-emphasis period TPE with respect to active lines belonging to the first line segment L_SEG1. The pre-emphasis controller 1420 may set the pre-emphasis period TPE so as to gradually increase from an active line adjacent to the second line segment point L_SEGP2 to the x-th active line ALx.

In contrast, referring to FIG. 12, the third line segment L_SEG3 may be set to be greater than the first and second line segments L_SEG1 and L_SEG2. The pre-emphasis controller 1420 may set the same pre-emphasis period TPE with respect to active lines belonging to the third line segment L_SEG3. The pre-emphasis controller 1420 may set the pre-emphasis period TPE so as to gradually decrease from an active line adjacent to the third line segment point L_SEGP3 to the first active line AL1.

To sum up, the pre-emphasis controller 1420 may set the same pre-emphasis period TPE with respect to a part of the plurality of active lines AL1 to ALx and may adjust the pre-emphasis period TPE with respect to the remaining active lines based on a distance between a current pixel and the output circuit 1440.

FIG. 13 is a view illustrating operations in which a pre-emphasis controller shown in FIG. 5 sets a pre-emphasis level based on line segment points, according to some embodiments of the inventive concept. As described above, in FIG. 9, the pre-emphasis controller 1420 may set the pre-emphasis period TPE in proportion to a distance between a current pixel and the output circuit 1440. In FIG. 13, the pre-emphasis controller 1420 may set the pre-emphasis level VPE in proportion to a distance between a current pixel and the output circuit 1440 instead of increasing the pre-emphasis period TPE. The pre-emphasis controller 1420 may adjust the pre-emphasis level VPE based on line segment points adjacent to a current pixel.

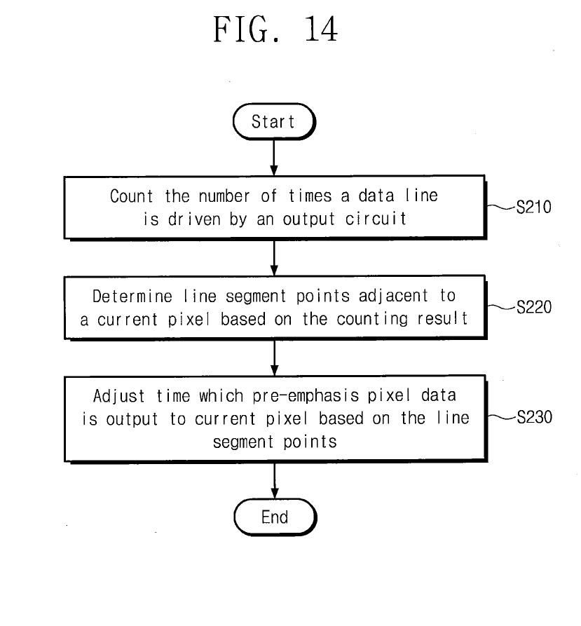

FIG. 14 is a flowchart illustrating operations in which a pre-emphasis controller shown in FIG. 5 sets a pre-emphasis period based on active lines, according to some embodiments of the inventive concept. FIG. 14 will be described with reference to FIGS. 2, 5, and 9.

In operation S210, the pre-emphasis controller 1420 may count the number of times that a data line is driven by the output circuit 1440. For example, the pre-emphasis controller 1420 may count the number of times that the data enable signal DE is activated. The data enable signal DE may be synchronized with pixel data being transmitted to the data driver 1400 and may indicate whether any part of the serial data is pixel data.

In operation S220, the pre-emphasis controller 1420 may determine line segment points adjacent to a current pixel based on the counting result. The pre-emphasis controller 1420 may determine how far a current pixel or an active line is distant from the output circuit 1440. For example, a distance between a current pixel and the output circuit 1440 may increase as the counting result becomes greater.

In operation S230, the pre-emphasis controller 1420 may generate pre-emphasis pixel data emphasizing the compare result of the comparator 1412 and may adjust a period, during which the pre-emphasis pixel data are output to a current pixel, based on line segment points adjacent to the current pixel. The pre-emphasis controller 1420 may transmit the pre-emphasis period control signals TPE_CTRL to the multiplexer 1416. Afterwards, the multiplexer 1416 may select one of current pixel data and pre-emphasis pixel data based on a period adjusted by the pre-emphasis controller 1420.

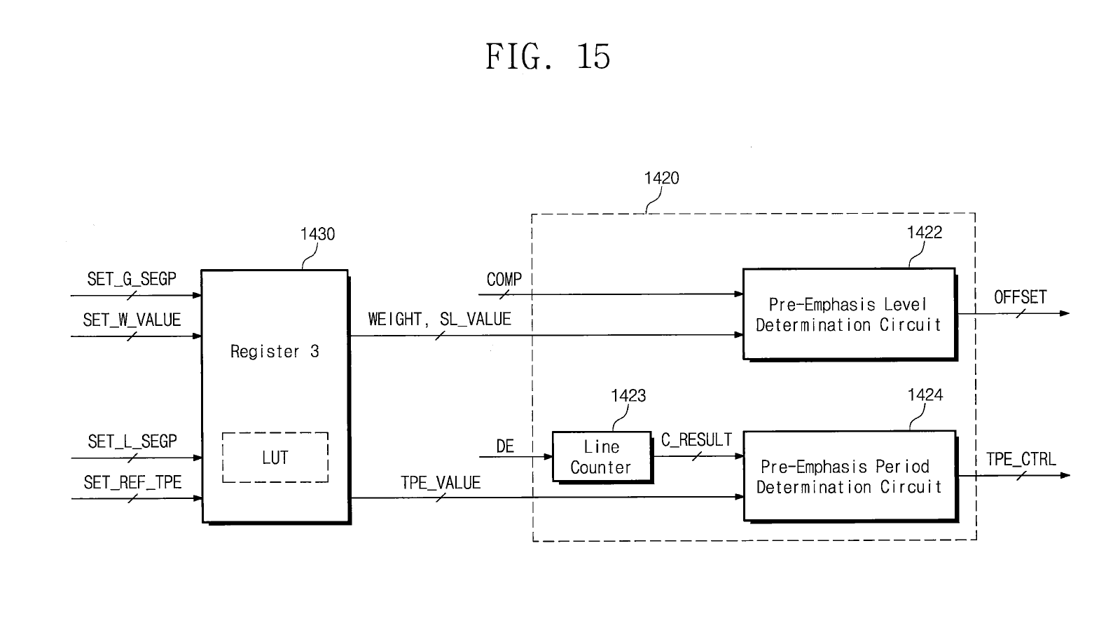

FIG. 15 is a block diagram illustrating a pre-emphasis controller and a third register shown in FIG. 5, according to some embodiments of the inventive concept. FIG. 15 will be described with reference to FIGS. 5 to 14. First, the third register 1430 that stores the lookup table LUT information will be described.

The third register 1430 may store the plurality of gamma segment points G_SEGP1 to G_SEGP9 for dividing a range of pixel data based on nonlinearity of a gray scale voltage for the pixel data. Also, the third register 1430 may store a plurality of weights and/or the plurality of slope values SL1 to SL8 for the plurality of gamma segments G_SEG1 to G_SEG8 defined by the plurality of gamma segment points G_SEGP1 to G_SEGP9.

The third register 1430 may provide a pre-emphasis level determination circuit 1422 with information about a gamma segment, which current pixel data belong to, with reference to gamma segment points adjacent to the current pixel data. For example, the third register 1430 may provide the pre-emphasis level determination circuit 1422 with a weight WEIGHT and a slope value SL_VALUE of a gamma segment to which the current pixel data belong. The slope value SL_VALUE may include the plurality of slope values SL1 to SL8.

The third register 1430 may store the plurality of line segment points L_SEGP1 to L_SEGP6 used as a reference for dividing a plurality of pixels, which include a previous pixel and a current pixel and are connected through one data line, into the plurality of line segments L_SEG1 to L_SEG5. Also, the third register 1430 may store a plurality of pre-emphasis period values for the plurality of line segments L_SEG1 to L_SEG5 defined by the plurality of line segment points L_SEGP1 to L_SEGP6. Each of the plurality of pre-emphasis period values may indicate how much a pre-emphasis period is set to a pixel. In an embodiment, the plurality of pre-emphasis period values may be values that are calculated by the pre-emphasis controller 1420 based on a reference pre-emphasis period value. In other embodiments, the plurality of pre-emphasis period values may be values that are provided from the outside.

The third register 1430 may provide the pre-emphasis period determination circuit 1424 with information about a line segment, which a current pixel belongs to, with reference to line segment points adjacent to the current pixel. For example, the third register 1430 may provide the pre-emphasis period determination circuit 1424 with a pre-emphasis period value TPE_VALUE of a line segment to which the current pixel belongs.

The third register 1430 may store information for a pre-emphasis operation. To this end, the third register 1430 may receive a gamma segment point set signal SET_G_SEGP, a weight set signal SET_W_VALUE, a line segment point set signal SET_L_SEGP, and a reference pre-emphasis period set signal SET_REF_TPE. The reference pre-emphasis period set signal SET_REF_TPE may include a reference pre-emphasis period value used to calculate the above-described pre-emphasis period values. Unlike the illustration, the third register 1430 may receive a plurality of pre-emphasis period values instead of the reference pre-emphasis period set signal SET_REF_TPE. In some embodiments, an external device may change information (e.g., a lookup table) stored in the third register 1430 by using the gamma segment point set signal SET_G_SEGP, the weight set signal SET_W_VALUE, the line segment point set signal SET_L_SEGP, and the reference pre-emphasis period set signal SET_REF_TPE.

In some embodiments, the lookup table may be configured to include the plurality of gamma segment points G_SEGP1 to G_SEGP9, the plurality of weights, the plurality of slope values SL1 to SL8, the plurality of line segment points L_SEGP1 to L_SEGP6, and the plurality of pre-emphasis period values. The lookup table may be stored in the third register 1430.

The pre-emphasis controller 1420 may include the pre-emphasis level determination circuit 1422, a line counter 1423, and a pre-emphasis period determination circuit 1424.

The pre-emphasis level determination circuit 1422 may perform operation S131 to operation S134, operation S141 to operation S144, or operation S160 of FIG. 8 based on the compare result COMP, the weight WEIGHT, and the slope value SL_VALUE. The pre-emphasis level determination circuit 1422 may provide an offset to the calculator 1413.

The line counter 1423 may count the number of times that a data line is driven by the output circuit 1440. To this end, the line counter 1423 may receive the data enable signal DE. The line counter 1423 may digitize how far a current pixel is from the output circuit 1440. The line counter 1423 may provide the counting result C_RESULT to the pre-emphasis period determination circuit 1424.

The pre-emphasis period determination circuit 1424 may receive the pre-emphasis period value TPE_VALUE of a line segment, which a current pixel belongs to, based on the counting result C_RESULT. The pre-emphasis period determination circuit 1424 may determine line segment points adjacent to the current pixel and a line segment, which the current pixel belongs to, based on the counting result C_RESULT and may provide the pre-emphasis period control signals TPE_CTRL to the multiplexer 1416 based on the pre-emphasis period value TPE_VALUE.

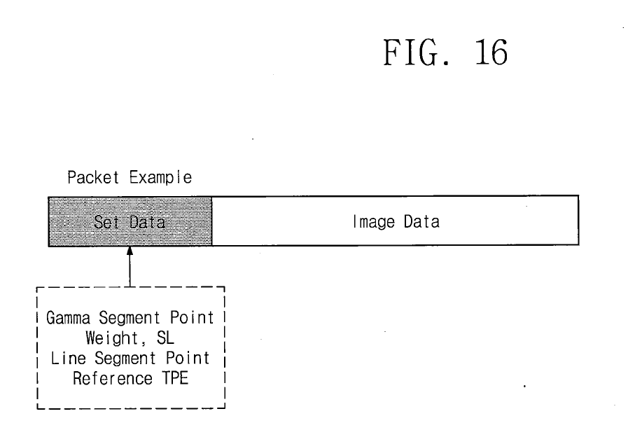

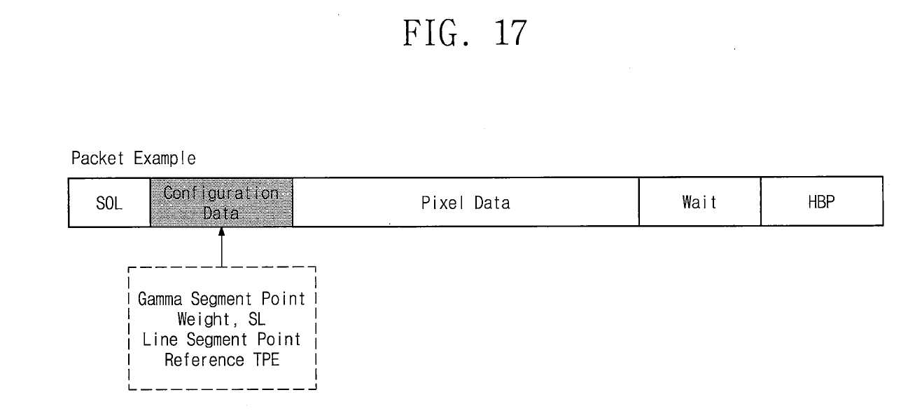

FIGS. 16 and 17 are views illustrating a packet configuration of serial data of FIG. 1 according to some embodiments of the inventive concept. FIGS. 16 and 17 will be described with reference to FIG. 2. Referring to FIG. 16, a serial data packet may be transmitted to the display device 1000 through a serial interface. The serial data packet may include set data and/or image data. The set data may be transmitted to the third register 1430 through the serial interface through which image data or pixel data are transmitted. The set data may be transmitted to the display device 1000 prior to the image data.

The set data may include information about a pre-emphasis operation, such as the plurality of gamma segment points G_SEGP1 to G_SEGP9, the plurality of weights, the plurality of slope values SL1 to SL8, the plurality of line segment points L_SEGP1 to L_SEGP6, and/or a reference pre-emphasis period value. The set data may be updated by an external device. In some embodiments, the serial data packet illustrated in FIG. 16 may be a serial data packet to be transmitted from the timing controller 1200 to the data driver 1400.

A serial data packet of FIG. 17 may indicate an example packet to be transmitted through an intra interface. Referring to FIG. 17, the serial data packet may include a start of line (SOL) field, a configuration data field, a pixel data field, a wait field, and/or a horizontal blank period (HBP) field.

The SOL field indicates a start of each line of an image frame. The SOL field may be a field for distinguishing a horizontal blank field for a previous line of a current image frame and a vertical blank period between the current image frame and a previous image frame.

As in the set data field of FIG. 16, the configuration data field may include information about a gamma segment point, weight information about a segment, information about a line segment point, and/or a reference pre-emphasis period value.

Pixel data to be displayed by the active line of a display panel are written in the pixel data field. The wait field may be a period that is allocated to secure a time needed for the data driver 1400 to receive and store pixel data. The horizontal blank period may be a period that is allocated to secure a time needed for the data driver 1400 to drive the display panel based on pixel data RGB. In some embodiments, the serial data packet illustrated in FIG. 17 may be a serial pixel data packet to be transmitted from the timing controller 1200 to the data driver 1400.

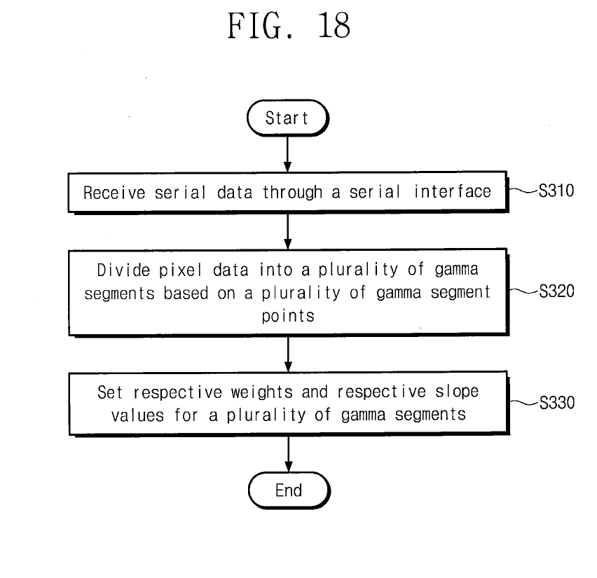

FIG. 18 is a flowchart illustrating operations in which a pre-emphasis controller processes set data, according to some embodiments of the inventive concept. The set data may include information about a pre-emphasis level, such as the plurality of gamma segment points G_SEGP1 to G_SEGP9, the plurality of weights, and/or the plurality of slope values SL1 to SL8.

In operation S310, the pre-emphasis controller 1420 may receive set data of serial data through a serial interface. In operation S320, the pre-emphasis controller 1420 may divide pixel data into the plurality of gamma segments G_SEG1 to G_SEG8 based on the plurality of gamma segment points G_SEGP1 and G_SEGP9. In operation S330, the pre-emphasis controller 1420 may set respective weight values and/or respective slope values with respect to the plurality of gamma segments G_SEG1 to G_SEG8.

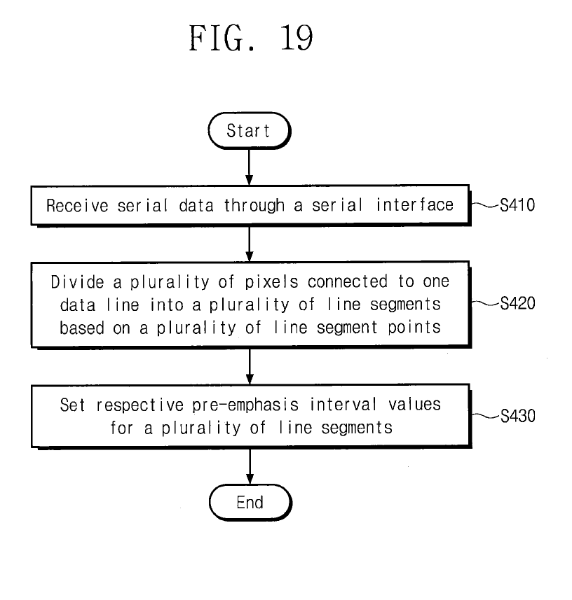

FIG. 19 is a flowchart illustrating operations in which a pre-emphasis controller processes set data, according to some embodiments of the inventive concept. The set data may include information about a pre-emphasis period, such as the plurality of line segment points L_SEGP1 to L_SEGP6 and/or the reference pre-emphasis period value.

In operation S410, the pre-emphasis controller 1420 may receive set data of serial data through a serial interface. In operation S420, the pre-emphasis controller 1420 may divide a plurality of pixels connected through one data line into the plurality of line segments L_SEG1 to L_SEG5 based on the plurality of line segment points L_SEGP1 and L_SEGP6. In operation S430, the pre-emphasis controller 1420 may set respective pre-emphasis period values with respect to the plurality of line segments L_SEG1 to L_SEG5.

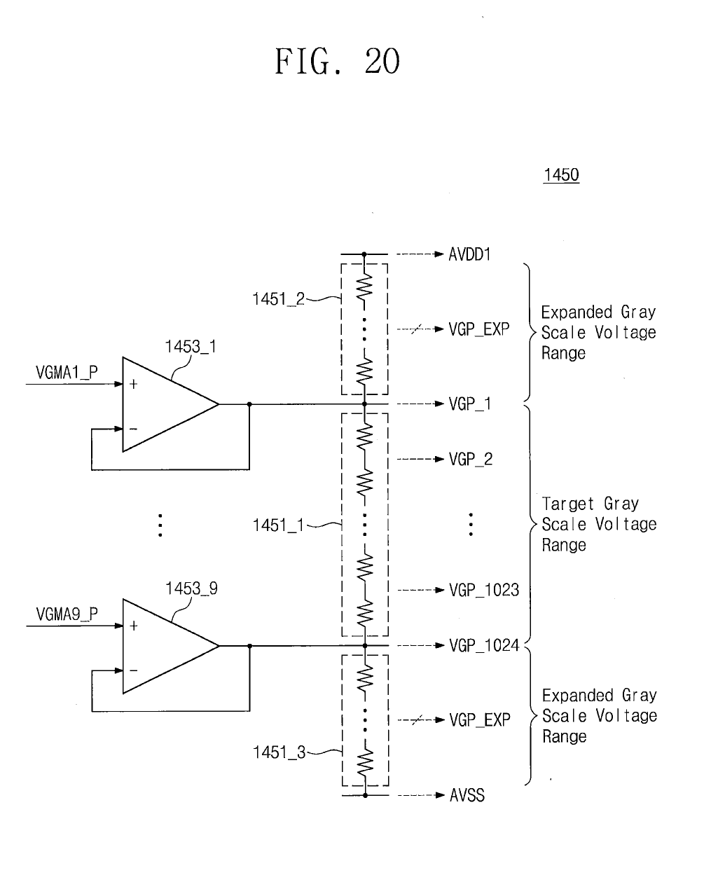

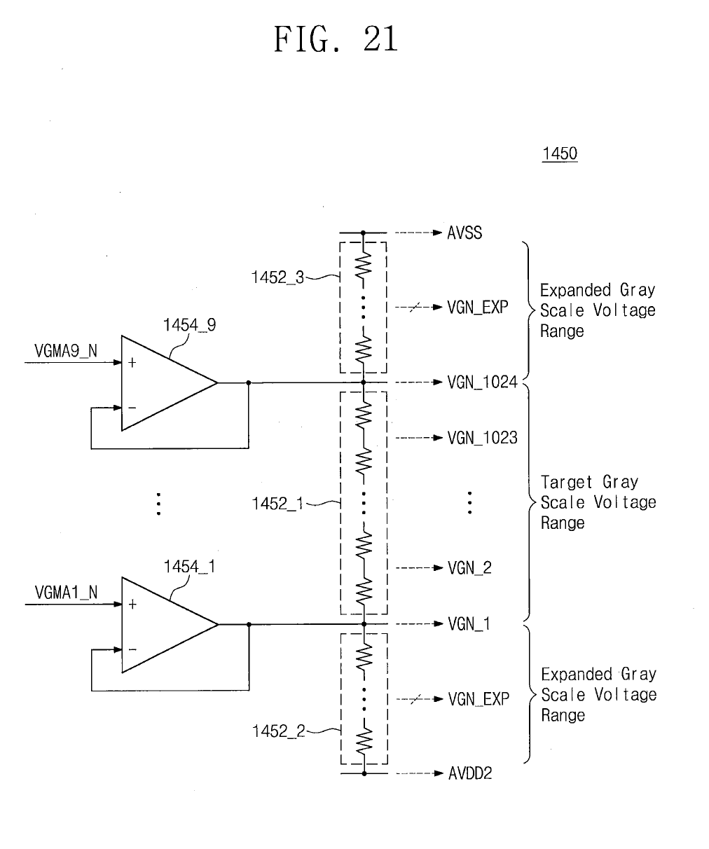

FIGS. 20 and 21 are circuit diagrams illustrating a gray scale voltage generator of FIG. 5 according to some embodiments of the inventive concept. FIGS. 20 and 21 will be described with reference to FIGS. 2 and 5. In the case where the display panel 1100 is an LCD panel, if an electric field is applied to a liquid crystal layer of a pixel only in one direction, the liquid crystal layer may be degraded. To reduce or eliminate degradation of the liquid crystal layer, a direction of an electric field applied to the liquid crystal layer may be periodically inverted. To invert the direction of the electric field, the gray scale voltage generator 1450 may generate a positive gray scale voltage and a negative gray scale voltage. FIG. 20 may be associated with generation of a positive gray scale voltage, and FIG. 21 may be associated with generation of a negative gray scale voltage. The gray scale voltage generator 1450 may generate a target gray scale voltage corresponding to current pixel data and a pre-emphasis gray scale voltage corresponding to pre-emphasis pixel data.

Referring to FIGS. 20 and 21, the gray scale voltage generator 1450 may include first to third positive resistor strings 1451_1 to 1451_3, first to third negative resistor strings 1452_1 to 1452_3, first to ninth positive gray scale voltage amplifiers 1453_1 to 1453_9, and first to ninth negative gray scale voltage amplifiers 1454_1 to 1454_9.

The first positive resistor string 1451_1 may generate a first set of 1024 positive gray scale voltages VGP_1 to VGP_1024. The number of first to 1024th positive gray scale voltages VGP_1 to VGP_1024 is determined by the number of bits of pixel data. For example, if pixel data are 10-bit data, the first positive resistor string 1451_1 may include resistors for generating 1024 (=2¹⁰) gray scale voltages. That is, the number of gray scale voltages and the number of resistors are only exemplary.

A range of the 1st to 1024th positive gray scale voltages VGP_1 to VGP_1024 may be a range of the above-described target gray scale voltage corresponding to current pixel data. A range of the pre-emphasis gray scale voltage may include a range of the target gray scale voltage and a range of an expanded gray scale voltage except for the range of the target gray scale voltage. To this end, the gray scale voltage generator 1450 may include the second and third positive resistor strings 1451_2 and 1451_3.

The second positive resistor string 1451_2 may be connected between the first positive gray scale voltage VGP_1 (an output of the first positive gray scale voltage amplifier 1453_1) and the first power voltage AVDD1 and may generate pre-emphasis gray scale voltages that are higher than the first positive gray scale voltage VGP_1 and lower than the first power voltage AVDD1. The third positive resistor string 1451_3 may be connected between the 1024th positive gray scale voltage VGP_1024 (an output of the ninth positive gray scale voltage amplifier 1453_9) and the second power voltage AVDD2 and may generate pre-emphasis gray scale voltages that are lower than the 1024th positive gray scale voltage VGP_1024 and higher than the second power voltage AVSS. Each of the second and third positive resistor strings 1451_2 to 1451_3 may generate gray scale voltages included in an expanded gray scale voltage range.

The first to ninth positive gray scale voltage amplifiers 1453_1 to 1453_9 may receive and amplify positive reference voltages VGMA1_P to VGMA9_P, respectively. The first positive gray scale voltage amplifier 1453_1 may generate a maximum gray scale voltage of a target gray scale voltage range, and the ninth positive gray scale voltage amplifier 1453_9 may generate a minimum gray scale voltage of the target gray scale voltage range. The positive reference voltages VGMA1_P to VGMA9_P may correspond to the reference voltages VGMA1 to VGMA9 described with reference to FIG. 6. The number of first to ninth positive gray scale voltage amplifiers 1453_1 to 1453_9 may be determined according to the number of gamma segment points G_SEGP1 to G_SEGP9.

The first to third negative resistor strings 1452_1 to 1452_3 and the first to ninth negative gray scale voltage amplifiers 1454_1 to 1454_9 may perform substantially the same function as the first to third positive resistor strings 1451_1 to 1451_3 and the first to ninth positive gray scale voltage amplifiers 1453_1 to 1453_9. However, the first to third negative resistor strings 1452_1 to 1452_3 and the first to ninth negative gray scale voltage amplifiers 1454_1 to 1454_9 may be connected to the second power voltage AVSS and the third power voltage AVDD2. Unlike the first power voltage AVDD1 being a positive power voltage, the third power voltage AVDD2 may be a negative power voltage, and an absolute value of the first power voltage AVDD1 may be different from or the same as an absolute value of the third power voltage AVDD2.

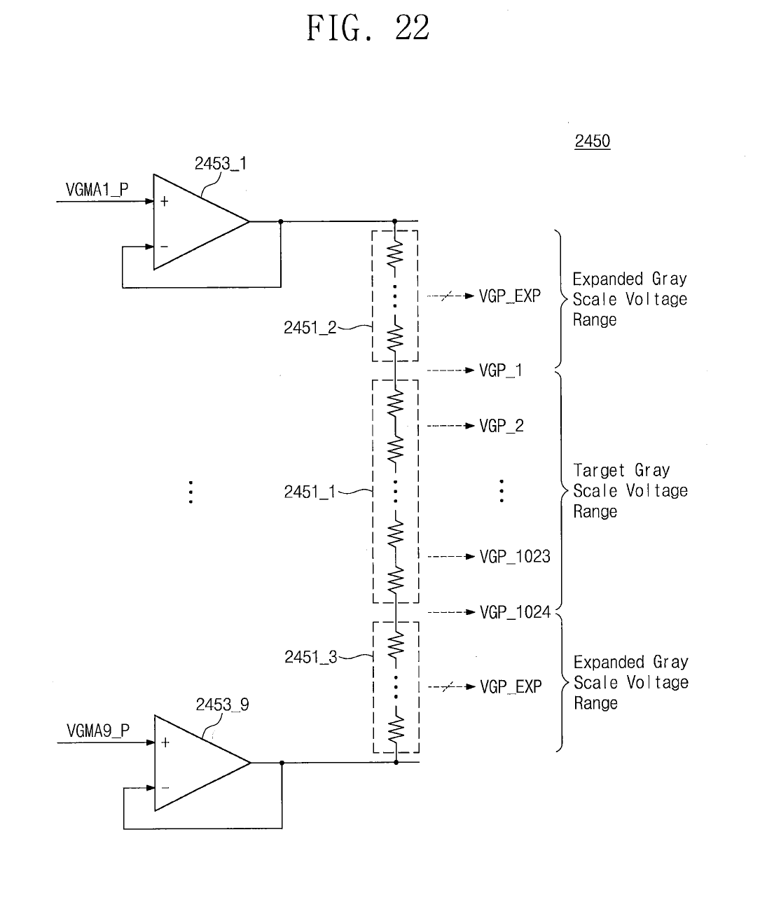

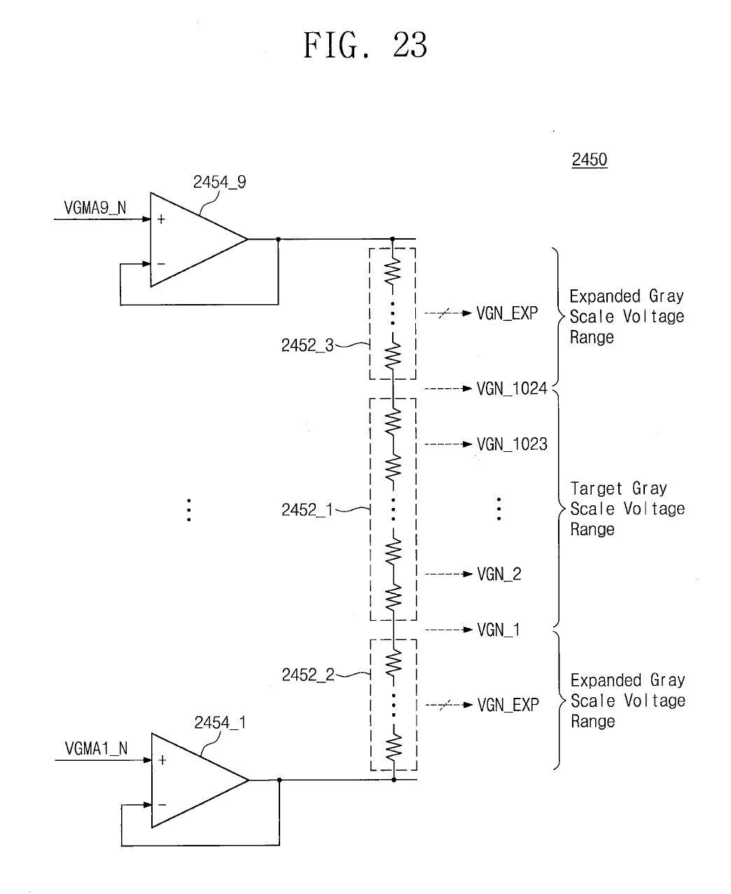

FIGS. 22 and 23 are circuit diagrams illustrating a gray scale voltage generator of FIG. 5 according to some embodiments of the inventive concept. FIG. 22 may be associated with generation of a positive gray scale voltage, and FIG. 23 may be associated with generation of a negative gray scale voltage. The gray scale voltage generator 2450 may generate a target gray scale voltage corresponding to current pixel data and a pre-emphasis gray scale voltage corresponding to pre-emphasis pixel data. Differences between the gray scale voltage generator 2450 and the gray scale voltage generator 1450 of FIGS. 20 and 21 will be described below.

Referring to FIGS. 22 and 23, the gray scale voltage generator 2450 may include first to third positive resistor strings 2451_1 to 2451_3, first to third negative resistor strings 2452_1 to 2452_3, first to ninth positive gray scale voltage amplifiers 2453_1 to 2453_9, and first to ninth negative gray scale voltage amplifiers 2454_1 to 2454_9. The first to third positive resistor strings 2451_1 to 2451_3 and the first to third negative resistor strings 2452_1 to 2452_3 may perform substantially the same function as the first to third positive resistor strings 1451_1 to 1451_3 and the first to third negative resistor strings 1452_1 to 1452_3.

The second positive resistor string 2451_2 may be connected to an output of the first positive gray scale voltage amplifier 2453_1 instead of the first power voltage AVDD1. The third positive resistor string 2451_3 may be connected to an output of the ninth positive gray scale voltage amplifier 2453_9 instead of the second power voltage AVSS. The second negative resistor string 2452_2 may be connected to an output of the first negative gray scale voltage amplifier 2454_1 instead of the third power voltage AVDD2. The third negative resistor string 2452_3 may be connected to an output of the ninth negative gray scale voltage amplifier 2454_9 instead of the second power voltage AVSS.

That is, the first positive gray scale voltage amplifier 2453_1 may generate a maximum gray scale voltage of a target gray scale voltage range, and the ninth positive gray scale voltage amplifier 2453_9 may generate a minimum gray scale voltage of the target gray scale voltage range. To adjust a pre-emphasis gray scale voltage range, in the gray scale voltage generator 1450, the number of resistors belonging to the second and third positive resistor strings 1451_2 and 1451_3 and the second and third negative resistor strings 1452_2 and 1452_3 may be adjusted. In other embodiments, the gray scale voltage generator 2450, the positive reference voltages VGMA1_P to VGMA9_P and negative reference voltages VGMA1_N to VGMA9_N may be adjusted instead of the adjusting the number of resistors.

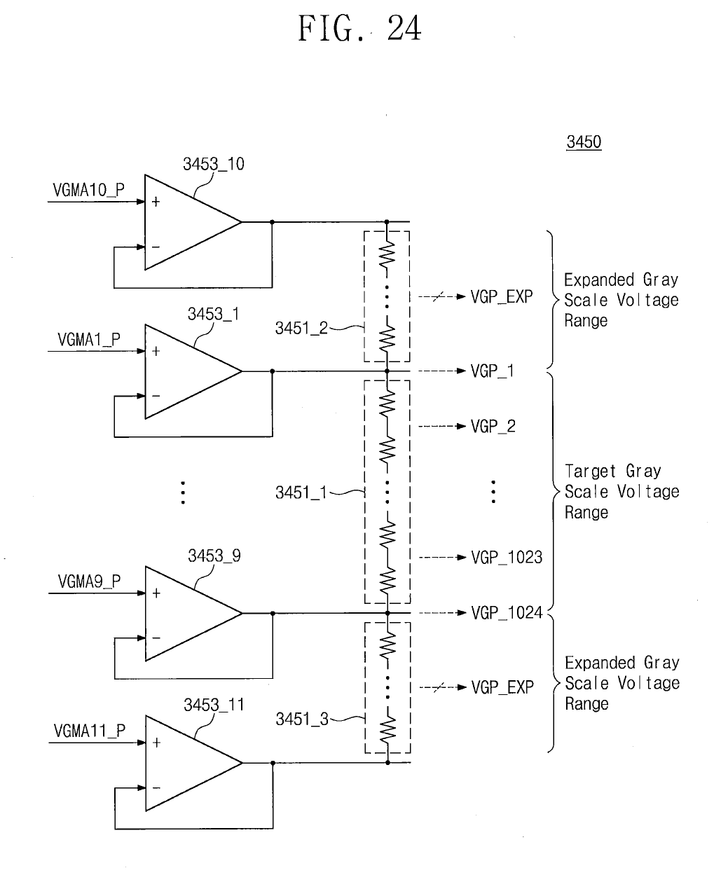

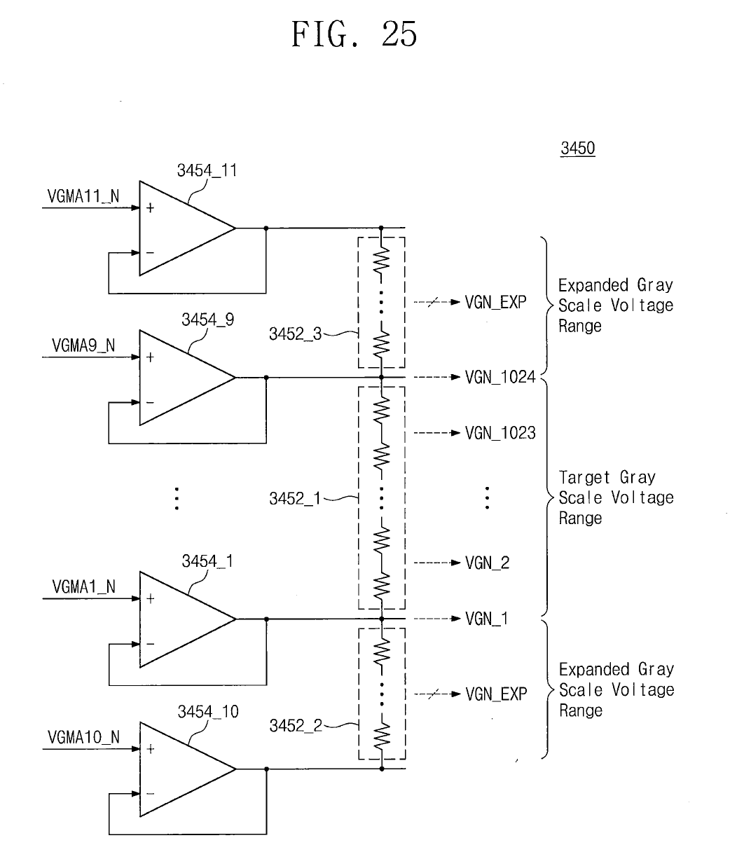

FIGS. 24 and 25 are circuit diagrams illustrating a gray scale voltage generator of FIG. 5 according to some embodiments of the inventive concept. FIG. 24 may be associated with generation of a positive gray scale voltage, and FIG. 25 may be associated with generation of a negative gray scale voltage. A gray scale voltage generator 3450 may generate a target gray scale voltage corresponding to current pixel data and a pre-emphasis gray scale voltage corresponding to pre-emphasis pixel data. Differences between the gray scale voltage generator 3450 and the gray scale voltage generator 1450 of FIGS. 20 and 21 will be described below.

Referring to FIGS. 24 and 25, the gray scale voltage generator 3450 may include first to third positive resistor strings 3451_1 to 3451_3, first to third negative resistor strings 3452_1 to 3452_3, first to ninth positive gray scale voltage amplifiers 3453_1 to 3453_9, and first to ninth negative gray scale voltage amplifiers 3454_1 to 3454_9. The first to third positive resistor strings 3451_1 to 3451_3 and the first to third negative resistor strings 3452_1 to 3452_3 may perform substantially the same function as the first to third positive resistor strings 1451_1 to 1451_3 and the first to third negative resistor strings 1452_1 to 1452_3.

Compared with the gray scale voltage generator 1450, the gray scale voltage generator 3450 may further include tenth and eleventh positive gray scale voltage amplifiers 3453_10 and 3453_11 and tenth and eleventh negative gray scale voltage amplifiers 3454_10 and 3454_11. Each of the tenth and eleventh positive gray scale voltage amplifiers 3453_10 and 3453_11 and tenth and eleventh negative gray scale voltage amplifiers 3454_10 and 3454_11 may generate gray scale voltages included in an expanded gray scale voltage range.

The second positive resistor string 3451_2 may be connected to an output of the tenth positive gray scale voltage amplifier 3453_1 instead of the first power voltage AVDD1. The third positive resistor string 3451_3 may be connected to an output of the eleventh positive gray scale voltage amplifier 3453_11 instead of the second power voltage AVSS. The second negative resistor string 3452_2 may be connected to an output of the tenth negative gray scale voltage amplifier 3454_10 instead of the third power voltage AVDD2. The third negative resistor string 3452_3 may be connected to an output of the eleventh negative gray scale voltage amplifier 3454_11 instead of the second power voltage AVSS.

To adjust a pre-emphasis gray scale voltage range, positive reference voltages VGMA10_P and VGMA11_P and negative reference voltages VGMA10_N and VGMA11_N may be adjusted. Also, to adjust a target gray scale voltage range, positive reference voltages VGMA1_P to VGMA9_P and negative reference voltages VGMA1_N to VGMA9_N may be adjusted. That is, the gray scale voltage generator 3450 may adjust both the target gray scale voltage range and the pre-emphasis gray scale voltage range by adjusting the reference voltages VGMA1_P to VGMA11_P and VGMA1_N to VGMA11_N.

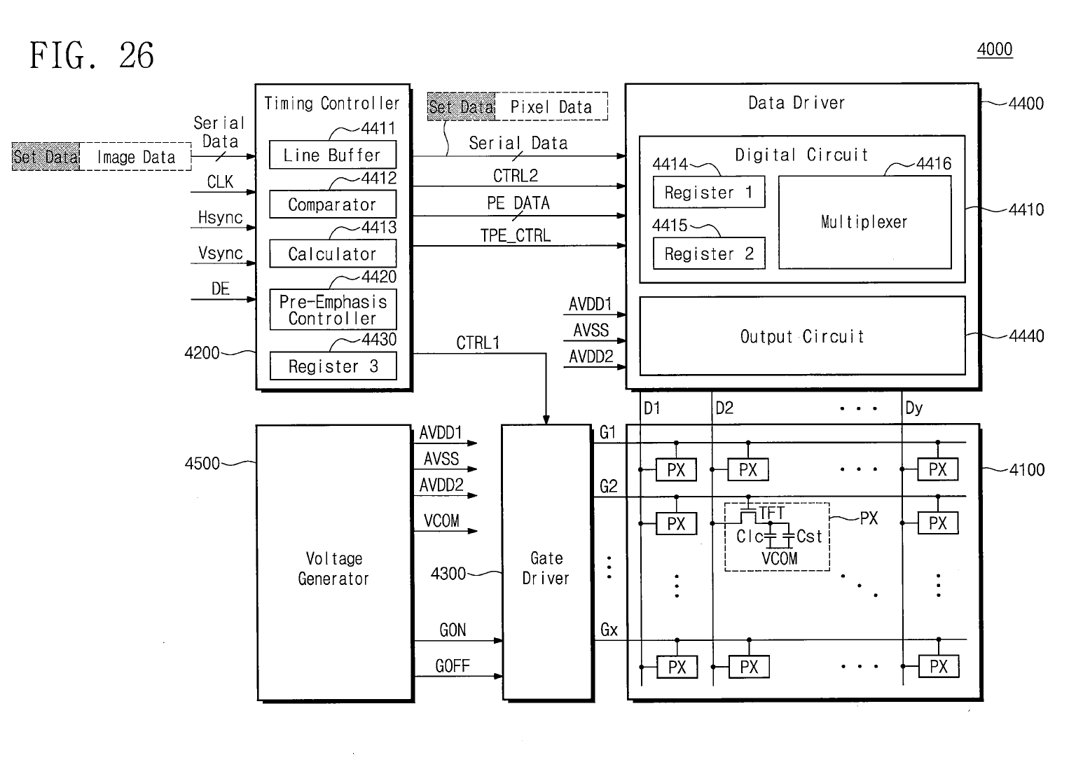

FIG. 26 is a block diagram illustrating a display device according to further embodiments of the inventive concept. Referring to FIG. 26, a display device 4000 may include a display panel 4100, a timing controller 4200, a gate driver 4300, a data driver 4400, and a voltage generator 4500. The display panel 4100, the gate driver 4300, and the voltage generator 4500 may perform substantially the same function as the display panel 1100, the gate driver 1300, and the voltage generator 1500 of FIG. 1. Differences between the display device 4000 and the display device 1000 of FIG. 1 will be described below.

Referring to FIG. 26, the timing controller 4200 may include a line buffer 4411, a comparator 4412, a calculator 4413, a pre-emphasis controller 4420, and a third register 4430. The data driver 4400 may include a digital circuit 4410 and an output circuit 4440, and the digital circuit 4410 may include first and second registers 4414 and 4415 and a multiplexer 4416.

The line buffer 4411, the comparator 4412, the calculator 4413, the first and second registers 4414 and 4415, the multiplexer 4416, the pre-emphasis controller 4420, and the third register 4430 may perform substantially the same function as the line buffer 1411, the comparator 1412, the calculator 1413, the first and second registers 1414 and 1415, the multiplexer 1416, the pre-emphasis controller 1420, and the third register 1430. That is, the pre-emphasis controller 4420, according to some embodiments of the inventive concept, and other circuits connected to the pre-emphasis controller 4420 may be implemented in any one of the timing controller 4200 or the data driver 4400.

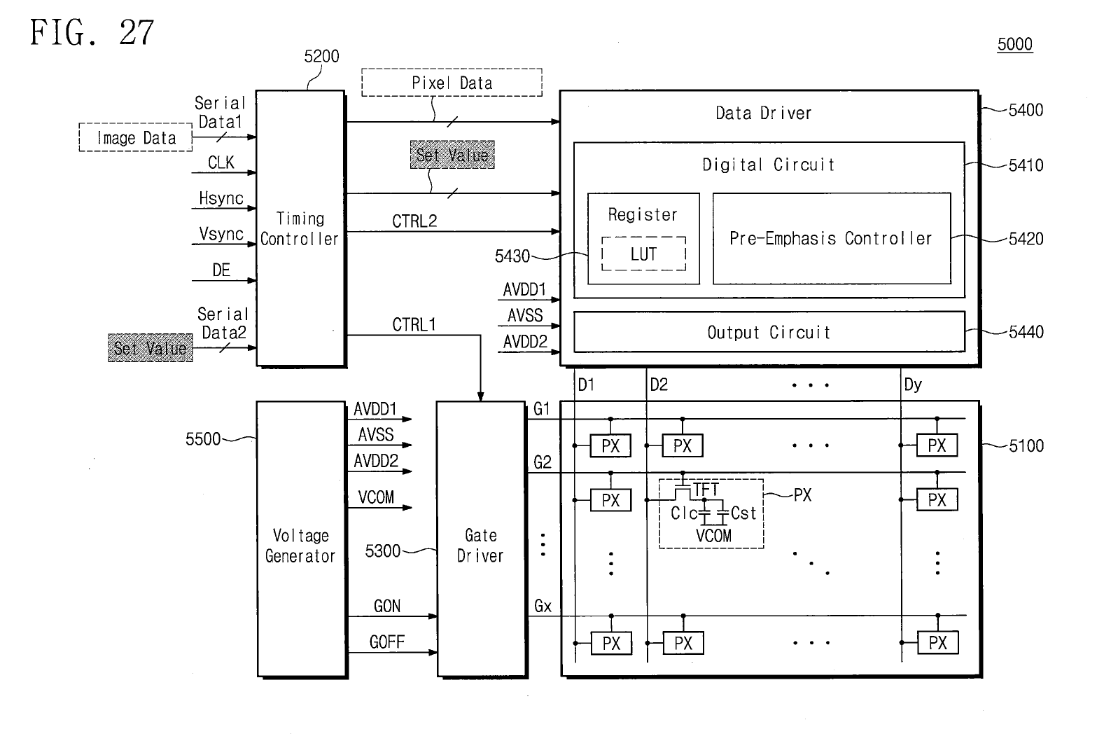

FIG. 27 is a block diagram illustrating a display device according to further embodiments of the inventive concept. Referring to FIG. 27, a display device 5000 may include a display panel 5100, a timing controller 5200, a gate driver 5300, a data driver 5400, and a voltage generator 5500. The display panel 5100, the gate driver 5300, and the voltage generator 5500 may perform substantially the same function as the display panel 1100, the gate driver 1300, and the voltage generator 1500 of FIG. 1. Differences between the display device 5000 and the display device 1000 of FIG. 1 will be described below.

The timing controller 5200 may receive set data through a dedicated terminal (not illustrated) different from a data terminal (not illustrated) for receiving image data. That is, the set data and the image data may be separately transmitted to the timing controller 5200. As in the above description, the data driver 5400 may receive the set data through a dedicated terminal (not illustrated) different from a data terminal (not illustrated) for receiving pixel data. That is, the set data and the image data may be separately transmitted to the data driver 5400. As described above, the set data may include information about a pre-emphasis operation, such as the plurality of gamma segment points G_SEGP1 to G_SEGP_9, the plurality of weights, the plurality of slope values SL1 to SL8, the plurality of line segment points L_SEGP1 to L_SEGP6, and/or a reference pre-emphasis period value.

A display driver circuit according to some embodiments of the inventive concept may adjust a pre-emphasis level in a digital manner based on nonlinearity of a gamma curve.

The display driver circuit according to some embodiments of the inventive concept may adjust a pre-emphasis period in consideration of a distance between a data driver and a data line.

The display driver circuit according to some embodiments of the inventive concept may generate a gray scale voltage for the pre-emphasis operation.

While the inventive concept has been described with reference to exemplary embodiments thereof, it will be apparent to those of ordinary skill in the art that various changes and modifications may be made thereto without departing from the spirit and scope of the inventive concept as set forth in the following claims.

What is claimed is:

1. A display driver circuit comprising:
a comparator configured to compare first pixel data of a plurality of pixel data with second pixel data of the plurality of pixel data, the plurality of pixel data respectively corresponding to a plurality of pixels connected to a data line;
a pre-emphasis controller configured to calculate an offset based on a compare result of the comparator and gamma segment points, which are adjacent to the second pixel data, from among a plurality of gamma segment points used as a reference for dividing the plurality of pixel data;
a calculator configured to calculate pre-emphasis pixel data based on the second pixel data and the offset; and
an output circuit configured to transmit a pre-emphasis gray scale voltage corresponding to the pre-emphasis pixel data and a target gray scale voltage corresponding to the second pixel data to a display panel through the data line.

2. The display driver circuit of claim 1, wherein the pre-emphasis controller is configured to calculate the offset by using at least one of a plurality of slope values that are respective ratios of a plurality of gray scale voltage ranges to a plurality of gamma segments between the plurality of gamma segment points.

3. The display driver circuit of claim 2, wherein the pre-emphasis controller is configured to calculate the offset by using at least one of a plurality of weights for the plurality of gamma segments, respectively.

4. The display driver circuit of claim 3, wherein the weight of the plurality of weights for the gamma segment of the plurality of gamma segments to which the second pixel data belong is a value that is based on a difference between the target gray scale voltage and a gray scale voltage corresponding to the first pixel data.

5. The display driver circuit of claim 3, further comprising:
a register configured to store a lookup table comprising the plurality of gamma segment points, the plurality of weights, and the plurality of slope values.

6. The display driver circuit of claim 5, wherein the register is configured to receive the plurality of gamma segment points, the plurality of weights, and the plurality of slope values through a serial interface that is configured to transmit the first pixel data and the second pixel data.

7. The display driver circuit of claim 5, wherein the register is configured to receive the plurality of gamma segment points, the plurality of weights, and the plurality of slope values through a dedicated terminal different from a data terminal configured to receive the first pixel data and the second pixel data.

8. The display driver circuit of claim 1, wherein the pre-emphasis controller is further configured to set a most significant bit of the offset based on the compare result.

9. The display driver circuit of claim 1, wherein the calculator is configured to:
calculate the pre-emphasis pixel data by adding the offset to the second pixel data when the second pixel data is greater than the first pixel data;
calculate the pre-emphasis pixel data by subtracting the offset from the second pixel data when the second pixel data is less than the first pixel data; and
calculate the second pixel data as the pre-emphasis pixel data when the second pixel data is the same as the first pixel data.

10. The display driver circuit of claim 1, wherein a number of bits of the pre-emphasis pixel data is more than a number of bits of the second pixel data.

11. A display driver circuit comprising:
a comparator configured to compare first pixel data with second pixel data to be output to a first pixel of a plurality of pixels and a second pixel of the plurality of pixels through a data line, respectively;
a register configured to store a plurality of line segment points used as a reference for dividing the plurality of pixels connected through the data line into a plurality of line segments;
a pre-emphasis controller configured to calculate an offset based on a compare result of the comparator and to adjust a period, during which the offset is output to the second pixel, based on ones of the line segment points of the plurality of line segment points adjacent to the second pixel; and
an output circuit configured to output the second pixel data and the offset to the second pixel through the data line based on the period adjusted by the pre-emphasis controller.

12. The display driver circuit of claim 11, wherein the pre-emphasis controller is further configured to count a number of times that the data line is driven by the output circuit and determine the ones of the line segment points adjacent to the second pixel based on a counting result.

13. The display driver circuit of claim 12, wherein the pre-emphasis controller is further configured to increase the period based on a distance between the second pixel and the output circuit.

14. The display driver circuit of claim 12, wherein the pre-emphasis controller is further configured to decrease the period based on a distance between the second pixel and the output circuit.

15. The display driver circuit of claim 11, wherein the register is configured to receive the plurality of line segment points through a serial interface that is configured to transmit the first pixel data and the second pixel data.

16. The display driver circuit of claim 11, wherein the register is configured to receive the plurality of line segment points through a dedicated terminal different from a data terminal configured to receive the first pixel data and the second pixel data.

17. A display driver circuit comprising:
a comparator configured to compare first pixel data with second pixel data to be output to a first pixel and a second pixel through a data line, respectively;
a pre-emphasis controller configured to calculate an offset based on a compare result of the comparator;
a calculator configured to calculate pre-emphasis pixel data based on the second pixel data and the offset;
a gray scale voltage generator configured to generate a pre-emphasis gray scale voltage corresponding to the pre-emphasis pixel data and a target gray scale voltage corresponding to the second pixel data; and
an output circuit configured to output the pre-emphasis gray scale voltage and the target gray scale voltage to a display panel through the data line,
wherein a range of the pre-emphasis gray scale voltage includes a range of the target gray scale voltage and a range of an expanded gray scale voltage except for the range of the target gray scale voltage.

18. The display driver circuit of claim 17, wherein the gray scale voltage generator comprises:
a first gray scale voltage amplifier configured to generate a maximum gray scale voltage of the range of the target gray scale voltage;
a second gray scale voltage amplifier configured to generate a minimum gray scale voltage of the range of the target gray scale voltage;
a first resistor string connected between the first gray scale voltage amplifier and a first power voltage and configured to generate a gray scale voltage that is included in the range of the expanded gray scale voltage and is greater than the maximum gray scale voltage; and
a second resistor string connected between an output of the second gray scale voltage amplifier and a second power voltage and configured to generate a gray scale voltage that is included in the range of the expanded gray scale voltage and is less than the minimum gray scale voltage.

19. The display driver circuit of claim 17, wherein the gray scale voltage generator comprises:
a first gray scale voltage amplifier configured to generate a maximum gray scale voltage of the range of the pre-emphasis gray scale voltage; and
a second gray scale voltage amplifier configured to generate a minimum gray scale voltage of the range of the pre-emphasis gray scale voltage.

20. The display driver circuit of claim 17, wherein the gray scale voltage generator comprises:
a first gray scale voltage amplifier configured to generate a maximum gray scale voltage of the range of the target gray scale voltage;
a second gray scale voltage amplifier configured to generate a minimum gray scale voltage of the range of the target gray scale voltage; and
a third gray scale voltage amplifier configured to generate a gray scale voltage included in the range of the expanded gray scale voltage.
